(19) United States
(12) Patent Application Publication
(10) Pub. No.: US 2025/0322384 A1
(43) Pub. Date: Oct. 16, 2025

(54) MOBILE APPLICATION TO EXPEDITE ACTIVATION OF CONTACTLESS CARDS

(71) Applicant: Capital One Services, LLC, McLean, VA (US)

(72) Inventors: Nicholas Capurso, Fairfax, VA (US); Dean Foster, Rockville, MD (US); Joshua Kuehn, Lowell, AR (US)

(73) Assignee: Capital One Services, LLC, McLean, VA (US)

(21) Appl. No.: 18/631,448

(22) Filed: Apr. 10, 2024

(51) Int. Cl. G06Q 20/34; G06F 21/32

(52) U.S. Cl. CPC G06Q 20/354; G06F 21/32

(57) ABSTRACT

A method, a system and a computer program product for expediting activation of contactless cards. An application on a computing device is executed upon the computing device detecting a contactless card to be located within a predetermined distance of the computing device. The computing device stores one or more computing device activation keys. The contactless card is an inactive contactless card. The stored computing device activation keys are accessed upon verifying one or more user authentication keys received in response to the executing. One or more contactless card activation keys are received. The contactless card activation keys are stored by the contactless card. The contactless card is activated based on a determination that the received contactless card activation keys match the stored computing device activation keys.

### TECHNICAL FIELD

This disclosure relates generally to data processing and, in particular, to contactless cards, and more particularly, to expediting activation of contactless cards using a mobile application.

### BACKGROUND

Tap-to-pay transactions have become some of the most popular ways of paying for goods and services. Tap-to-pay is based on radio-frequency identification (RFID) technology that may be embedded into credit cards, smartphones, and other mobile devices. This technology allows users to make credit card transactions by bringing their cards and/or smartphones within a specific distance of (or tapping on) specific areas of point-of-sale terminals, which enables transfer of certain data for the purposes of making a payment. Prior to employing tap-to-pay features, the devices, cards, etc. having such capability typically must be appropriately activated. However, existing activation processes usually are multi-step operations that are error-prone and may result in failure to activate such devices, cards, etc., preventing access to funds, execution of transactions, etc.

### SUMMARY

In some implementations, the current subject matter relates to a computer implemented method for expediting activation of contactless cards using a mobile application. The method may include executing, using at least one processor, an application on a computing device upon the computing device detecting a contactless card to be located within a predetermined distance of the computing device. The computing device may store one or more computing device activation keys. The contactless card may be an inactive contactless card. The method may also include accessing the stored computing device activation keys upon verifying one or more user authentication keys received in response to the executing, receiving one or more contactless card activation keys, where the contactless card activation keys may be stored by the contactless card, and activating the contactless card based on a determination that the received contactless card activation keys match the stored computing device activation keys.

In some implementations, the current subject matter may include one or more of the following optional features. The activating may include sending the received contactless card activation keys and the stored computing device activation keys to at least one server. The server may be communicatively coupled to the computing device.

In some implementations, the server may be configured to execute a comparison of the received contactless card activation keys and the stored computing device activation keys, and determine, based on the comparison, whether the received contactless card activation keys match the stored computing device activation keys. Upon a determination of a match between the received contactless card activation keys and the stored computing device activation keys, the server may transmit an activation signal to the contactless card to activate the contactless card. Upon a failure to determine a match between the received contactless card activation keys and the stored computing device activation keys, the server may prevent transmission of the activation signal to the contactless card.

In some implementations, the server may be configured to transmit the computing device activation keys to the computing device.

In some implementations, the executing may include executing a near-field communication (NFC) exchange between the contactless card and the computing device upon the contactless card being detected by the computing device to be located within the predetermined distance of the computing device.

In some implementations, the executing may include automatically triggering, based on the NFC exchange, generation of at least one user interface, at least one user interface including one or more prompts for entry of the user authentication keys.

In some implementations, the user authentication keys may include at least one of the following: a facial recognition data, a fingerprint data, a biometric data, a username and a password, a multi-factor authentication token, and any combination thereof.

In some implementations, the contactless card may include at least one of the following: a credit card, a debit card, an electronic gift card, a pre-paid credit card, a pre-paid debit card, and any combination thereof.

In some implementations, the computing device may be configured to execute a comparison of the received contactless card activation keys and the stored computing device activation keys, and determine, based on the comparison, whether the received contactless card activation keys match the stored computing device activation keys. Upon a determination of a match between the received contactless card activation keys and the stored computing device activation keys, the device may transmit an activation signal to the contactless card to activate the contactless card. Upon a failure to determine a match between the received contactless card activation keys and the stored computing device activation keys, the device may prevent transmission of the activation signal to the contactless card.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A illustrates an exemplary system for activating a contactless card, according to some implementations of the current subject matter;

FIG. 1B illustrates another exemplary system for activating a contactless card, according to some implementations of the current subject matter;

FIG. 2 illustrates an example activation process for activating a contactless card, according to some implementations of the current subject matter;

FIG. 3 illustrates another example activation process for activating a contactless card, according to some implementations of the current subject matter;

FIG. 4 illustrates another example activation process for activating a contactless card, according to some implementations of the current subject matter;

FIG. 5 illustrates a data transmission system, according to some implementations of the current subject matter;

FIG. 6 illustrates a data transmission system, according to some implementations of the current subject matter;

FIG. 7A illustrates a contactless card, according to some implementations of the current subject matter;

FIG. 7B illustrates a transaction card component, according to some implementations of the current subject matter;

FIG. 8 illustrates a sequence flow, according to some implementations of the current subject matter;

FIG. 9 illustrates a data structure, according to some implementations of the current subject matter;

FIG. 10 is a diagram of a key system, according to some implementations of the current subject matter;

FIG. 11 is a flowchart of a method of generating a cryptogram, according to some implementations of the current subject matter;

FIG. 12 depicts an exemplary process illustrating key diversification, according to some implementations of the current subject matter;

FIG. 13 illustrates a method for card activation, according to some implementations of the current subject matter;

FIG. 14 illustrates an example of a system, according to some implementations of the current subject matter;

FIG. 15 illustrates an example flow to perform card key derivation, according to some implementations of the current subject matter;

FIG. 16 illustrates an aspect of the subject matter in accordance with one embodiment;

FIG. 17 illustrates an aspect of the subject matter in accordance with one embodiment;

FIG. 18 illustrates an aspect of the subject matter in accordance with one embodiment;

FIG. 19 illustrates an aspect of the subject matter in accordance with one embodiment;

FIG. 20 illustrates an aspect of the subject matter in accordance with one embodiment;

FIG. 21 illustrates an example of a process, according to some implementations of the current subject matter;

FIG. 22 illustrates an aspect of the subject matter in accordance with one embodiment;

FIG. 23 illustrates an aspect of the subject matter in accordance with one embodiment; and

FIG. 24 illustrates a computer architecture, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide an ability to expedite activation of contactless cards using mobile devices and/or application and/or any other devices.

Contactless cards, such as, credit cards, gift cards, pre-paid cards, etc. typically must be activated prior to use. The activation process can ensure that an authorized card user has received the card. Further, such an identity of the authorized user and/or any information associated with the contactless card can be verified so that the card can begin to be used. The activation process usually involves the user, having the possession of the contactless card, call a call center, which may be associated with the financial institution (e.g., a bank) that has issued the card, and provide information associated with the user and/or the card for verification. Once the information is verified at the call center, the call center may activate the contactless card for use.

Alternatively, or in addition, the contactless card may be activated using a mobile application that may be executed on a mobile device. The mobile application may be associated with the financial institution that issued the card. The application may require the user that received the card to provide user identification information (e.g., a facial recognition data, a fingerprint data, a biometric data, a username and a password, a multi-factor authentication token, and any combination thereof etc.) for user authentication purposes so that the user can be granted access a secure portion of the application. Once access is granted, the user may be asked to provide card identification information, e.g., card account number, CCV number, user mailing address' zip code, and/or any other information to verify the card and/or the user as being authorized to use the card.

Once the contactless card is activated, the financial institution that issued the card may list the card at one or more of its servers as being activated, where the servers may be accessed by third parties (e.g., merchants, etc.) to verify the card. The user may also begin using the card to, for example, make purchases, access funds, verify user's identity, etc. In case of purchase transactions, the user may present the activated contactless card to the merchant for payment. The merchant through, for example, merchant's point-of-sale terminal, may verify that the card is activated and may be used for purchasing. The point-of-sale terminal may transmit a request to the financial institution's server to verify the card and receive appropriate authorization for a purchase transaction that is desired by the user.

However, existing card activation processes may make it challenging to execute card activation process. For example, call centers responsible for card activation might not be available and/or may incorrectly activate the card rendering it unusable. Electronic activation of the contactless card can involve multiple steps that need to be precisely executed otherwise the card may remain inactive and/or unusable, leaving the user to wait for another card.

In some implementations, the current subject matter may be configured to execute contactless card activation process using tap-to-device feature of the card. The current subject matter may be further configured to perform the activation process without requiring the user to execute multiple steps associated with user and/or card authentication. To execute the current subject matter's card activation process, the contactless card may be preloaded and/or imprinted with (e.g., during manufacturing) with a secret key and/or any other data that may be used to authenticate the card and/or the user for activation purposes. Such secret key/data may be preloaded onto the contactless card's chip and stored in its memory location. The secret key/data may also be provided to an application, such as, for example, a mobile application, associated with the financial institution that has issued the contactless card to the user. The application may be loaded and/or operating on a user's computing device (e.g., a mobile telephone, a smartphone, a tablet, a personal computer, etc.) and may allow the user to access user's financial account that may be associated with the financial institution (e.g., user's bank, etc.).

In some implementations, the secret key/data may be provided to the application at the same time, prior to, and/or after the user has received the un-activated contactless card from the financial institution. The secret key/data may also be stored in the memory of the contactless card and/or provided to the application in an encrypted form. The secret key/data may be encrypted using various methods, such as, for example, using user's biometric data (e.g., a fingerprint, a face identification, etc.) and/or any other user identification data (e.g., a facial recognition data, a fingerprint data, a biometric data, a username and a password, a multi-factor authentication token, and any combination thereof, etc.).

Once the user receives the un-activated contactless card, the user may be prompted to open the application on the user's computing device and/or login into user's account associated with the financial institution that issued the card. Alternatively, or in addition, the user may tap the contactless card on the user's computing device, which may trigger opening of the application. Then, the user may be prompted to provide user's identification data, e.g., user's biometric data, various other user specific data, etc. (e.g., a facial recognition data, a fingerprint data, a biometric data, a username and a password, a multi-factor authentication token, and any combination thereof, etc.). The provided identification data may be used to decrypt the secret key/data that may be stored on the contactless card and/or the application.

The contactless card may then provide the decrypted secret key/data to the user's computing device, which, in turn, may execute a comparison between the received decrypted secret key/data and the one stored by the application running on the user's computing device. Upon matching of the two secret keys/data, the user's computing device may transmit an activation signal to the contactless card to activate it. Otherwise, activation of the card is prevented. Alternatively, or in addition, the user's computing device may be configured to transmit the received secret key/data to a server communicatively coupled with the user's computing device and/or associated with the financial institution that issued the card. The server may execute the comparison of the received secret key/data with the secret key/data stored on the server and determine whether there is a match. In some example, alternate implementations, the server may receive the decrypted secret key/data from both the contactless card and the user's computing device and perform the comparison, where the secret key/data from the contactless card may be transmitted to the server from the user's computing device.

Alternatively, or in addition, the contactless card, upon being tapped on the user's computing device, may provide an encrypted secret key/data that has been stored in its memory to the user's computing device. Upon receiving the encrypted secret key/data from the contactless card, the user's computing device may be configured to decrypt the received encrypted secret key/data using user's identification data, e.g., user's biometric data, various other user specific data, etc. (e.g., a facial recognition data, a fingerprint data, a biometric data, a username and a password, a multi-factor authentication token, and any combination thereof, etc.). Once decrypted, the user's computing device may execute comparison on the decrypted user's identification data and the one stored by the computing device. If a match between the two is determined, the user's computing device may generate one or more activation signals and transmit same to the contactless card to activate it. Otherwise, the contactless card may remain un-activated.

In some implementations, the current subject matter may be configured to execute a near field communication (NFC) exchange between the contactless card and the user's computing device, upon the computing device detecting that the contactless card is located within a predetermined distance from the computing device. The computing device may be configured to act as an “active” component and provide power to energize the contactless card, which may be considered as a “passive” component. The NFC exchange may be configured to trigger opening of the application on the user's computing device and/or providing of the secret key/data (e.g., in decrypted and/or encrypted form) to the user's computing device.

In some implementations, upon detecting the contactless card within a predetermined area of the user's computing device, the computing device may request and/or be automatically provided with various identification data from the contactless card, which may include the secret key/data (e.g., in decrypted and/or encrypted form). The card's identification data may include various information identifying the card and/or the user of the card. It may include one or more identifiers that may be used to identify the card. The contactless card may also transmit various contactless card data. This data may be transmitted as part of the activation process and/or subsequently to activation of the card. The contactless card data may include the contactless card data includes at least one of the following: an account number associated with the contactless card, an expiration date associated with the contactless card, a card verification value (CVV) associated with the contactless card, a billing address associated with the contactless card, a name of a user associated with the contactless card, and any combination thereof. In some implementations, the computing device may be configured to store the received contactless card data and/or transmit it to one or more servers that may be communicatively coupled to the computing device and associated with the financial institution that issued the card. As stated above, the server(s) may also execute comparison of the secret key/data received from the contactless card.

In some implementations, the server(s) may also store information associated with the card, the user that it is issued to, security and/or authentication information, any activation data that may be necessary to activate the card, and/or any other information. Alternatively, or in addition to, the information may be stored in one or more storage locations (e.g., a database) that the server(s) may query and retrieve data that the server(s) may need for processing. The server(s) may process the data received from the user's computing device. This may include decrypting any data that may have been encrypted by the computing device prior to sending to the server, extracting information from data packets that are received from the computing device, comparing the received information with data that the server(s) may have stored and/or extracted from a storage location, and generating a response as a result of the comparison, and/or any other operations. The response may include generation of an authentication data authenticating the contactless card and/or generation of an error/alert indicating that the contactless card has not been authenticated and hence, further operations may be prevented. Alternatively, or in addition, the server(s) may transmit a request to the computing device to request the contactless card to provide further and/or different information for authentication at the server(s).

In some implementations, as part of the activation process, the application executing on the user's computing device may be configured to generate one or more user interface screens that may display one or more fillable fields. The user interface screens may be automatically populated based on the contactless card data received from the contactless card and/or any authentication data received from the server(s). Further, the screens may be different for different types of contactless cards that are being activated. By way of a non-limiting example, the contactless card may be at least one of the following: a credit card, a debit card, an electronic gift card, a pre-paid credit card, a pre-paid debit card, and any combination thereof.

In some example implementations, the current subject matter relates to a method for activating a contactless card using a computing device (e.g., a mobile device, and/or any other type computing device). The computing device may be associated with a user to whom the contactless card may be issued by a financial institution. The user may have a financial account with the financial institution. The user's computing device may include, for example, a smartphone, a tablet computer, a laptop, etc. The computing device may be configured to have a wireless communication capability, such as, Bluetooth™, Wi-Fi, cellular communication, near-field communication, etc. The computing device may also include one or more processors, memory, graphical user interface and/or any other computing hardware and/or software components.

The computing device may be configured to execute an application upon the computing device detecting the contactless card to be located within a predetermined distance of the computing device. The computing device may also be configured to store one or more computing device activation keys that may be used to during activation of the contactless card. The contactless card may be an inactive and/or un-activated contactless card. The computing device activation keys may be provided to and stored by the computing device prior to activation of the contactless card. Alternatively, or in addition, such keys may be provided to the computing device upon computing device requesting the keys from a server that may be associated with the financial institution issuing the card.

The computing device may be configured to receive one or more user authentication keys (e.g., user's identification data, e.g., user's biometric data, various other user specific data, etc. (e.g., a facial recognition data, a fingerprint data, a biometric data, a username and a password, a multi-factor authentication token, and any combination thereof, etc.)). For example, the user may be prompted using one or more computing device's user interface screens to provide such user authentication keys. Upon verifying the provided user authentication keys, the computing device may then be configured to access the stored computing device activation keys.

The computing device may also be configured to receive one or more contactless card activation keys from the contactless card. The contactless card activation keys may be stored by the contactless card (e.g., as stated above, such keys may have been implanted and/or stored on the contactless card during the manufacturing and/or encoding process of the contactless card). The contactless card activation keys may be provided by the contactless card upon the card being located within a predetermined distance from the computing device.

The contactless card activation keys, as received by the computing device, may be compared with the computing device activation keys. The computing device may execute the comparison and/or the keys (the contactless card activation keys and/or the computing device activation keys) may be provided to a server to perform the comparison. If a match between two sets of keys is determined, the contactless card may be activated (e.g., by transmitting an activation signal to the card).

With general reference to notations and nomenclature used herein, the detailed descriptions herein may be presented in terms of program procedures executed on a computer or network of computers. These procedural descriptions and representations are used by those skilled in the art to effectively convey the substance of their work to others skilled in the art.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identify, perform a payment, launch applications, login into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as a banks, to issue contactless cards with tap-to functions to customers while maintaining a high-level security. The systems discussed differ from previous solutions because they provide a single platform for multiple issuers to provide the tap-to functionality. Traditionally, each issuer must set up and maintain their own systems to provide contactless card features. This includes maintaining their own hardware, software, databases, security protocols, and so forth, which can become extremely costly for the issuer to maintain. However, embodiments discussed enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that another issuer cannot access another issuer's data or functions. As will be discussed in more detail, these features may be provided by a switchboard system that is configured to process and perform each contactless card function in a secure manner. Additional benefits for issuers may include providing a highly secure authentication option for mobile web, which typically lack the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact. The term “coupled,” however, may also mean that two or more elements are not in direct contact with each other, but yet still cooperate or interact with each other.

Various embodiments also relate to apparatus or systems for performing these operations. This apparatus may be specially constructed for the required purpose, or it may include a computer as selectively activated or reconfigured by a computer program stored in the computer. The procedures presented herein are not inherently related to a particular computer or other apparatus. Various machines may be used with programs written in accordance with the teachings herein, or it may prove convenient to construct more specialized apparatus to perform the required method steps. The required structure for various machines will appear from the description given.

In the figures and the accompanying description, the designations “a” and “b” and “c” (and similar designators) are intended to be variables representing any positive integer. Thus, for example, if an implementation sets a value for a=5, then a complete set of components 123 illustrated as components 123-1 through 123-a (or 123a) may include components 123-1, 123-2, 123-3, 123-4, and 123-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

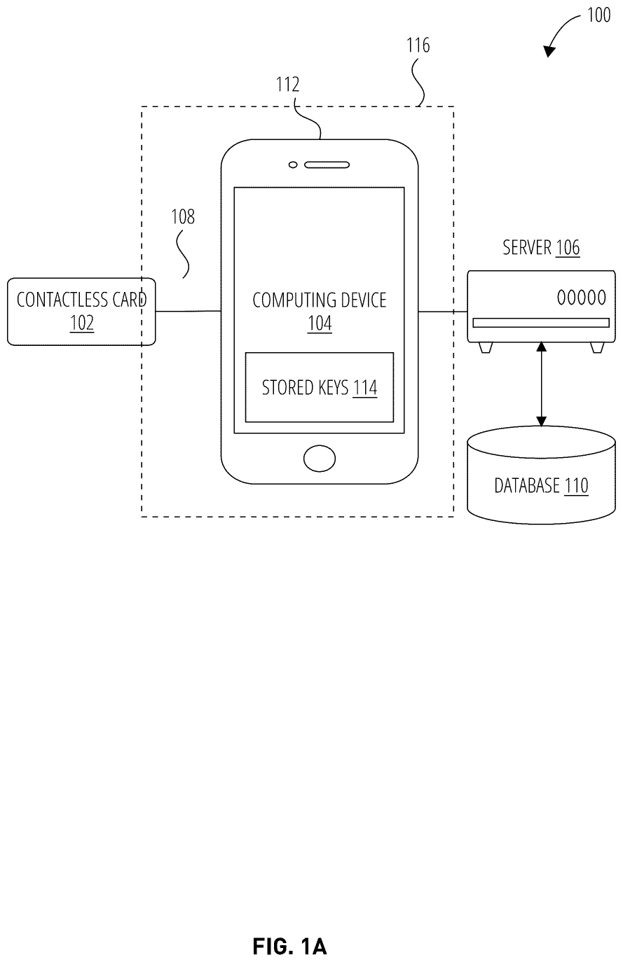

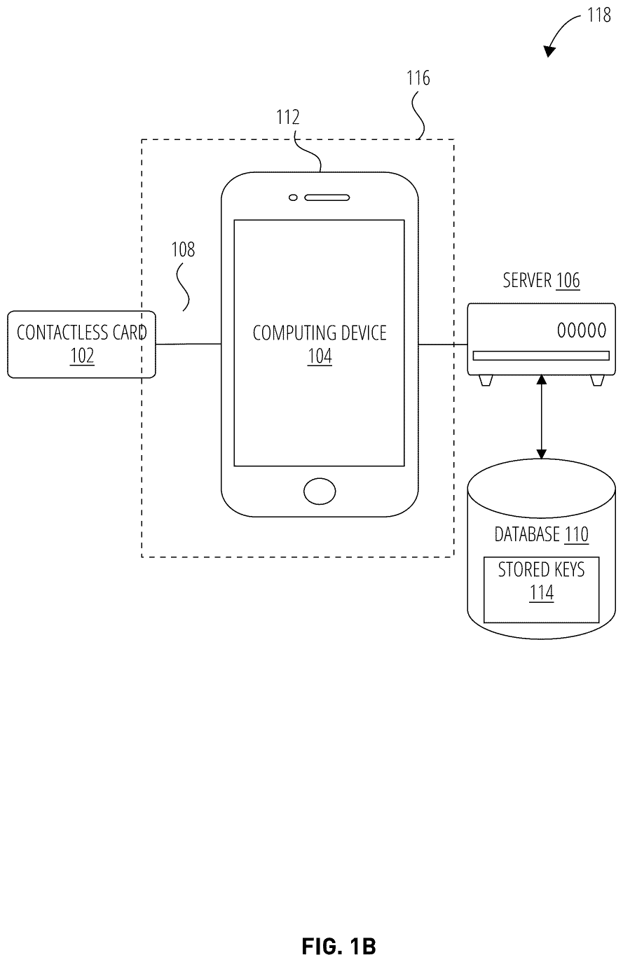

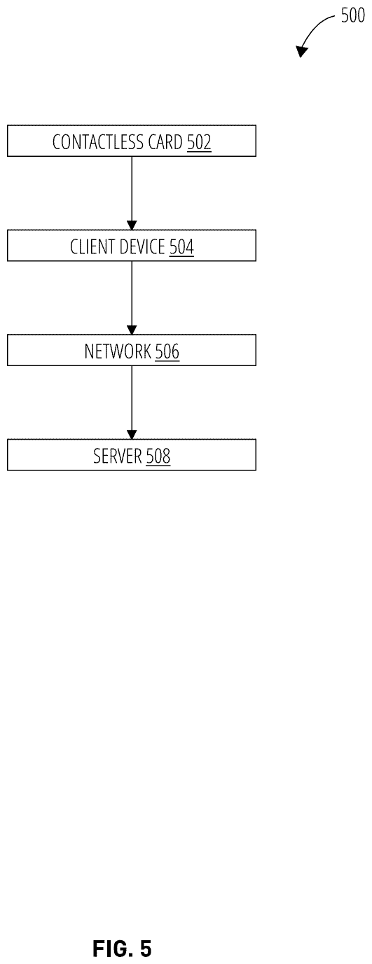

FIG. 1A illustrates an exemplary system 100 for activating a contactless card, according to some implementations of the current subject matter. The system 100 may include a contactless card 102, a mobile device or any computing device 104 (referred to herein as a “computing device”), a server 106, and a database 110. The contactless card 102 may have one or more features discussed below in connection with FIGS. 5-24. The computing device 104 may be configured to have a predetermined area and/or geofence 116 that may be configured to surround the computing device 104. The computing device 104 may be configured to detect one or more objects, such as, the contactless card 102, upon entry of the object into the predetermined area 116. Alternatively, or in addition, the computing device 104 may be configured to detect such an object upon the object being positioned within a predetermined distance away from the computing device 104, where the predetermined distance may be defined by the area 116.

One or more components of the system 100 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, one or more components of the system 100 may include any combination of hardware and/or software. In some implementations, one or more components of the system 100 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, one or more components of the system 100 may be disposed on a single computing device and/or may be part of a single communications network. Alternatively, or in addition to, such services may be separately located from one another. A service may be a computing processor, a memory, a software functionality, a routine, a procedure, a call, and/or any combination thereof that may be configured to execute a particular function associated with the current subject matter lifecycle orchestration service(s).

In some implementations, the system 100's one or more components may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 100 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the environment 100 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some example implementations, one or more components of the environment 100 may execute one or more applications, such as software applications, that enable, for example, network communications with one or more components of environment 100 and transmit and/or receive data.

One or more components of the environment 100 may include and/or be in communication with one or more servers via one or more networks and may operate as a respective front-end to back-end pair with one or more servers. One or more components of the environment 100 may transmit, for example from a computing device application (e.g., executing on one or more user devices, components, etc.), one or more requests to one or more servers (e.g., server(s) 106). The requests may be associated with retrieving data from servers. The servers may receive the requests from the components of the system 100. Based on the requests, servers may be configured to retrieve the requested data from one or more databases (e.g., database 110, as shown in FIG. 1A). Based on receipt of the requested data from the databases, the servers may be configured to transmit the received data to one or more components of the system 100, where the received data may be responsive to one or more requests.

The system 100 may include one or more networks. In some implementations, networks may be one or more of a wireless network, a wired network or any combination of wireless network and wired network and may be configured to connect the components of the system 100 and/or the components of the system 100 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 100.

One or more components of the system 100 may be configured to execute one or more transactions using one or more containers. In some implementations, each transaction may be executed using its own container. A container may refer to a standard unit of software that may be configured to include the code that may be needed to execute the action along with all its dependencies. This may allow execution of actions to run quickly and reliably.

In some implementations, as discussed above, the system 100 may be used for execution of activation of the contactless card 102. In particular, the activation may be executed using near-field communications (NFC) exchange link 108 between the contactless card 102 and the computing device 104. To enable use of the NFC technology, a user (not shown in FIG. 1A) may bring the contactless card 102 within the area 116 of the computing device 104 (e.g., tap the card 102 on the computing device 104), whereby the computing device 104 may be configured to detect presence of the contactless card 102 within the area 116 and execute one or more operations discussed herein. For example, the NFC 108 may be used in connection with activation of the contactless card, as well as, for example, subsequent to activation, any payment transactions and/or any other tasks, transactions, etc.

In the NFC exchange link 108, the computing device 104 may be configured to act as an active component and provide power to energize the contactless card 102 (as discussed herein), which may be a passive component. Using the link 108, the computing device 104 and the contactless card 102 may be configured to exchange various data, such as, for instance, for the purposes of activating the contactless card 102.

In some implementations, as discussed herein, the computing device 104 may be securely linked to user's financial account at the financial institution that issued the contactless card and where the user may access the financial account either before, during and/or after the card activation. The contactless card 102 may likewise be securely linked to the user's account. The linking of the computing device 104 and the account may be configured to allow the computing device 104 to execute the activation processes, where certain data and/or information associated with the card (e.g., secret keys/data) and stored by the computing device (e.g., stored keys 114) is compared to determine whether the card can be activated. Access to the account from the computing device 104 may be secured/protected using various authentication/authorization mechanisms (e.g., a facial recognition data, a fingerprint data, a biometric data, a username and a password, a multi-factor authentication token, and any combination thereof, etc.).

Once the computing device 104 detected the contactless card 102 within the area 116, the computing device 104, using the NFC link 108, may be configured to request and/or be automatically provided with various identification data from the contactless card 102. The identification data may include various information identifying the card and/or the user of the card (e.g., one or more identifiers, etc.). In some implementations, the contactless card 102 may be configured to provide one or more activation keys that may have been “implanted” and/or stored on the contactless card 102 during, for example, manufacturing of the card. Upon receipt of the activation keys from the contactless card 102, the computing device 104 may be configured to retrieve one or more stored keys 114 that may be stored in a memory of the computing device 104. The stored keys 114 may have been provided to the computing device 104 prior to and/or during the activation process of the contactless card 102. The keys 114 may be requested by the computing device 104 from, for example, the server 106. Alternatively, or in addition, the keys 114 may be transmitted to the computing device 104 (e.g., from the server 106) upon the user accessing user's financial account (e.g., using a mobile application being executed on the computing device 104) associated with the contactless card 102. Moreover, the keys 114 may be requested by the computing device 104 and/or provided to the computing device 104 (e.g., from the server 106) upon the computing device 104 detecting the contactless card 102 within the area 106 and/or upon opening a mobile application being executed on the computing device 104. In some implementations, execution of the mobile application may be triggered upon the computing device 104 detecting the contactless card 102 within the area 116.

In some implementations, once the activation keys are received from the contactless card, the computing device 104 may be configured to compare the received keys with the stored keys 114. Upon determining a match between the two sets of keys, the computing device 104 may be configured to transmit an activation signal to the contactless card 102 to activate it. The mobile application being executed on the computing device 104 may generate a user interface indicating that the contactless card 102 has been activated and may be used. Otherwise, if no match is determined, the computing device 104 does not transmit an activation signal and the contactless card 102 may remain un-activated or inactive. The computing device 104 may prompt the contactless card 102 to again provide the contactless card 102's activation keys and repeat the comparison process. Moreover, the mobile application being executed on the computing device 104 may generate a user interface screen indicating that the contactless card 102 has not been activated and/or that activation is in progress. If the card 102 cannot be activated, the mobile application may generate another user interface screen prompting the user to contact the financial institution for resolution of any issues associated with card activation.

In some example, non-limiting implementations, the contactless card 102 may be configured to be preloaded with multiple sets of contactless card activation keys. In turn, the computing device 104 may be provided with one or more activation keys for storage as keys 114. Such provided keys may be transmitted to the computing device 104 on a dynamic basis and may be rotatable. Thus, when the contactless card 102 is requested to provide its contactless card activation keys to the computing device, the contactless card 102 may be configured to provide one or more of its stored activation keys to the computing device 104 for comparison. If the computing device 104 determines that a match exists between one or more such contactless card activation keys and its stored keys 114, the computing device 104 may be configured to transmit an activation signal to the contactless card 102 to activate it. The contactless card 102 may be configured to select one or more of its contactless card activation keys randomly and/or in any predetermined order for transmission to the computing device 104.

The computing device 104 may also be configured to transmit the contactless card activation keys that it has received from the contactless card 102 to the server 106. The server 106 may execute a comparison between the contactless card activation keys that were received from the computing device 104 and the keys that are stored by the server 106 (e.g., in a database 110). If a match is determined, the server 106 may transmit an activation signal to the computing device 104, which may, in turn, transmit it to the contactless card 102 for activation of the card. Otherwise, if a match cannot be determined, the server 106 may transmit a signal to the computing device 104 and indicate that the card 102 cannot be activated, causing the mobile application running on the computing device 104 to generate a user interface screen to that effect and/or prompting the user to contact the financial institution.

In some example implementations, the contactless card 102 may be configured to transmit contactless card data that may be stored on the card to the computing device 104. Transmission of such data may be performed as part of the activation process and/or subsequently thereafter. The contactless card data may also be requested by the computing device 104 to verify authenticity of the contactless card 102. The data may also be transmitted, by the computing device 104, to the server 106 for any verification and/or further verification/authentication. Some non-limiting examples of the contactless card data may include at least one of the following: an account number associated with the contactless card, an expiration date associated with the contactless card, a card verification value (CVV) associated with the contactless card, a billing address associated with the contactless card, a name of a user associated with the contactless card, etc. Transmission of data to the server 106 may be performed via any desired type of network. The computing device 104 may be configured to transmit data to the server 106 in one or more data packets.

The server 106 may be configured to store various data associated with the contactless card 102, the user that it is issued to, security and/or authentication information, keys that may be used for activation and/or use of the card, etc. In some example implementations, the server 106 may also issue a query to the database 110, which may store some and/or all of the above and/or any other information related to the contactless card 102. The query may be used to search the database 110 to retrieve requested data. The data stored by the server 106 and/or in the database 110 may have been previously stored, such as, for example, when the contactless card 102 has been issued and/or manufactured by the issuer of the card.

In some implementations, transmissions of data between the contactless card 102, the computing device 104, and/or the server 106 may be encrypted. Moreover, the data, including any secret keys, activation keys, stored keys, contactless card data, etc., may be encrypted. Thus, the computing device 104 and/or server 106 may execute various decryption algorithms to decrypt the data that they receive. Once the data has been decrypted, information may be extracted from the data packets. Further, prior to transmission of data (e.g., processed data, stored data, etc.), one or more components of the system 100, e.g., the contactless card 102, the computing device 104, and/or the server 106, may encrypt the data using any desired encryption algorithms.

In some implementations, the mobile application that may be executed on the computing device 104 may be configured to generate one or more user interfaces on the computing device 104. Such user interfaces may include one or more fillable fields, which may be used for entry of various user authentication information, e.g., a facial recognition data, a fingerprint data, a biometric data, a username and a password, a multi-factor authentication token, and any combination thereof, to access user's account at the financial institution, such as, for example, to authenticate the user for the purposes of activating the contactless card 102. Moreover, the user interfaces may also include one or more fields that may be automatically populated based on the contactless card data received from the contactless card 102 and/or any data that may be stored by the computing device 104 and/or received from the server 106. For example, the computing device 104 may be configured to populate the fillable fields upon activating the contactless card 102, where the fields may be populated with the contactless card data.

FIG. 1B illustrates an exemplary system 118 for activating a contactless card, according to some implementations of the current subject matter. The system 118 is similar to the system 100 shown in FIG. 1A and may include the contactless card 102, the mobile device or any computing device 104, the server 106, and the database 110. The system 118 may be configured to operate similarly to the system 100, however, in the system 118, the computing device 104, instead of storing the stored keys 114 and/or receiving them from the server 106, may be configured to communicate with the server 106 for the purpose of activating the contactless card 102. The server 106 may, in turn, either store the stored keys 114 and/or communicate with the database 110 that may store the stored keys 114.

Once the activation keys are received by the computing device 104 from the contactless card 102, the computing device 104 may be configured to send the received keys to the server 106 for performing comparison of the received activation keys with the stored keys 114. Upon determining a match between the two sets of keys, the server 106 may be configured to transmit an activation signal to the computing device 104, which may, in turn, transmit it to the contactless card 102 to activate it. The mobile application being executed on the computing device 104 may generate a user interface indicating that the contactless card 102 has been activated and may be used. Otherwise, if no match is determined, the server 106 does not transmit an activation signal to the computing device 104 and the contactless card 102 may remain un-activated or inactive. The computing device 104 may prompt the contactless card 102 to again provide the contactless card 102's activation keys and repeat the comparison process with the server 106 executing the comparison again using another set of activation keys. Moreover, the mobile application being executed on the computing device 104 may generate a user interface screen indicating that the contactless card 102 has not been activated and/or that activation is in progress. If the card 102 cannot be activated, the mobile application may generate another user interface screen prompting the user to contact the financial institution for resolution of any issues associated with card activation. As can be understood, the contactless card 102 may be activated using a combination of mobile and/or computing device or devices 104 and the server(s) 106. The stored keys 114 may be stored on the computing device 104 and/or the server 106 and/or database 110 and/or in any other location. The comparison of the stored keys 114 and card's activation keys may be executed at any and/or all of the devices. Further, activation signals may be sent from any of the devices (e.g., device 104, server 110, etc.).

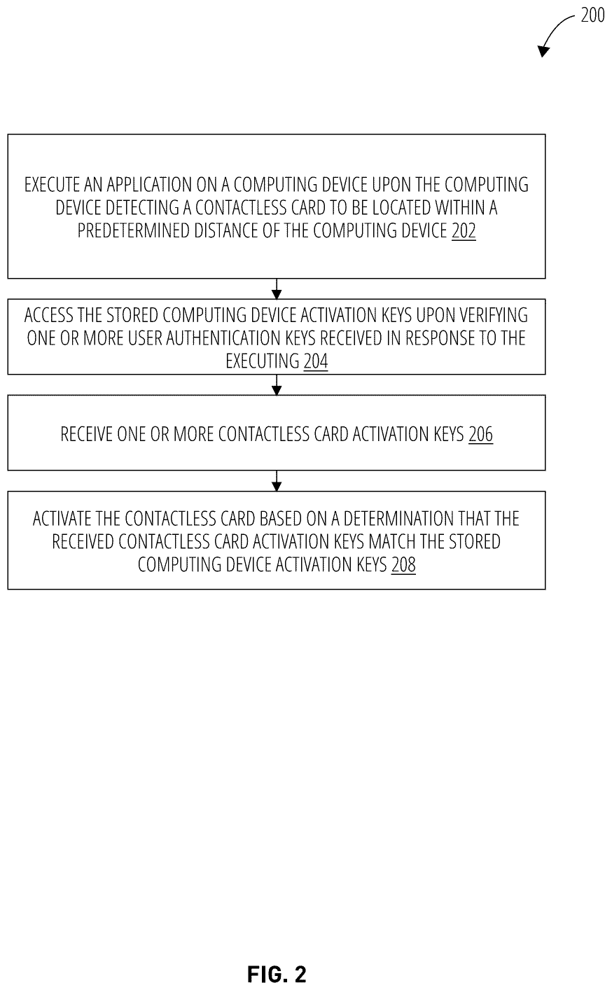

FIG. 2 illustrates an example activation process 200 for activating a contactless card, according to some implementations of the current subject matter. The process 200 may be executed by one or more components of the system 100 shown in FIGS. 1A-B. For example, the process 200 may be executed by and/or between the computing device 104 and the contactless card 102 via an NFC exchange link 108 that may be established between the card 102 and the computing device 104 upon the computing device 104 detecting the contactless card 102 entering the area 116.

In some implementations, the process 200 may be executed in connection with activation of the contactless card 102 that may have been issued by a financial institution to a user that may have a financial account at the financial institution. The user may be able to access the financial account using one or more authentication keys, and/or data and/or information, such as, for example, a facial recognition data, a fingerprint data, a biometric data, a username and a password, a multi-factor authentication token, and any combination thereof. To do so, the user may use a mobile application that may be executed and/or opened and/or running on the computing device 104. The mobile application may be associated with the financial institution that has issued the contactless card 102. To access the user's financial account, the mobile application may prompt the user to enter the authentication keys/data/information (e.g., a facial recognition data, a fingerprint data, a biometric data, a username and a password, a multi-factor authentication token, and any combination thereof, etc.).

Once the contactless card 102 has been issued to the user, one or more contactless card activation keys may also be generated. The keys may be stored on the contactless card 102 (e.g., during manufacturing of the card process) in encrypted and/or unencrypted format. The activation keys may also be provided to the computing device 104 and may be stored on the computing device 104 as stored keys 114, as shown in FIGS. 1A-B. Further, the activation keys may be provided to the computing device 104 upon detecting that the user has accessed the mobile application on the computing device 104, for example, subsequent to the manufacture of the contactless card 102. The activation keys may also be provided to the computing device 104 without the user accessing the mobile application on the computing device 104 (e.g., as part of an application background processes, updates, etc.). Alternatively, or in addition, the activation keys may be stored on the server 106 and/or database 110, as shown in FIGS. 1A-B.

At 202, the computing device 104 may be configured to execute a mobile application on the computing device 104 upon the computing device 104 detecting the contactless card 102 within the area 116. As stated above, the area 116 may be a predetermined area and/or distance from the computing device 104. The contactless card 102 may be configured to have been received by the user and may be in an un-activated and/or inactive form. Positioning of the contactless card 102 within the area/distance 116 may cause the computing device 104 to detect presence of the card and transmit an energizing signal to energize contactless card 102's circuits, thereby triggering transmission of one or more signals from the contactless card 102 to the computing device 104. Such signal(s) may trigger opening of the mobile application on the computing device 104. Alternatively, or in addition, the mobile application may be automatically opened on the computing device upon detection of card 102 within area/distance 116. The mobile application may also be manually opened by the user on the computing device 104.

In some implementations, the computing device 104 may already be configured to have received, from, for example, server 106 and/or database 110, device activation keys for activation of the card 102 and may have stored them as stored keys 114. Alternatively, or in addition, the device activation keys may be requested by the computing device 104 from, for example, server 106 and/or database 110, upon detection of presence of the contactless card 102 within the area/distance 116. The keys may also be requested by the computing device 104 prior to and/or upon the user accessing the financial account using the mobile application.

Upon detecting the contactless card 102 within the area/distance 116, the computing device 104 may be configured to execute a near-field communication (NFC) exchange between the contactless card 102 and the computing device 104. Moreover, the computing device 104 may be configured to automatically trigger, based on the NFC exchange, generation of at least one user interface that may be associated with the mobile application. The user interface may, for example, include one or more prompts for entry of one or more user authentication keys. The user authentication keys may include, for example, at least one of the following: a facial recognition data, a fingerprint data, a biometric data, a username and a password, a multi-factor authentication token, and any combination thereof.

At 204, the computing device 104 may be configured to verify user's authentication keys. The verification may be executed locally by the computing device 104 and/or transmitted to the server 106 for verification. Once the authentication keys have been verified either by the computing device 104 and/or the server 106, the computing device 104 may be configured to access the stored device activation keys 114.

At 206, the computing device 104 may be configured to receive one or more contactless card activation keys that have been stored on the contactless card 102 (e.g., during manufacture). The contactless card activation keys may be provided to the computing device 104 upon a request from the computing device 104. Alternatively, or in addition, the contactless card activation keys may be provided automatically upon the establishment of the NFC exchange link 108 between the contactless card 102 and the computing device 104. Moreover, the contactless card activation keys may be provided upon receiving an indication from the computing device 104 that the mobile application has been opened and/or appropriate activation user interfaces and/or application programming interfaces may have initiated.

The contactless card activation keys may be provided in an encrypted and/or unencrypted form. Such keys may be transmitted via an encrypted and/or unencrypted NFC exchange link 108. The computing device 104 may be configured to execute one or more decryption algorithms to decrypt any encrypted contactless card activation keys. The contactless card activation keys may be in any desired format, e.g., alpha-numeric, image files, etc.

At 208, the contactless card 102 may be activated based on a determination that the received contactless card activation keys match the stored device activation keys 114. The contactless card 102 may be activated by the computing device 104 and/or by the server 106 (communicatively coupled to the computing device 104) and/or both and/or any other device.

If the contactless card 102 is activated by the server 106, the computing device 104 may be configured to transmit and/or send the received contactless card activation keys (as received from the contactless card 102) and the stored device activation keys 114 to the server 106. The server may be configured to execute a comparison between the received contactless card activation keys and the stored device activation keys 114.

Based on the comparison, the server 106 may be configured to determine whether the received contactless card activation keys match the stored device activation keys 114. Upon determining that a match between the received contactless card activation keys and the stored device activation keys 114 exists, the server 106 may be configured to transmit an activation signal to the contactless card 102 to activate the contactless card 102. The activation signal may be transmitted directly to the contactless card 102 (e.g., when the card is used) and/or to the computing device 104, which may provide the activation signal to the contactless card 102 to cause its activation. However, upon failing to determine a match between the two sets of keys, the server 106 may be configured to prevent transmission of the activation signal to the contactless card 102. The server 106 may transmit a signal to the computing device 104 indicating that the contactless card has not been activated. The signal may also cause the computing device 104 to generate one or more user interfaces associated with the mobile application indicating failure to activate the contactless card and/or prompting the user to contact the financial institution for any further actions.

If the computing device 104 is executing the activation (e.g., with and/or without communications with the server 106), the computing device 104 may be configured to execute a comparison of the received contactless card activation keys (as received from the contactless card 102 via and/or as a result of the NFC exchange link 108) and the stored device activation keys 114. As stated above, the contactless card activation keys may be stored on the contactless card 102, for example, during manufacture of the contactless card 102. The device activation keys 114 may be provided to the computing device 104 for the purposes of activation of the contactless card 102.

Based on the comparison, the computing device 104 may be configured to determine whether the received contactless card activation keys match the stored device activation keys 114. Upon determining that a match between the received contactless card activation keys and the stored device activation keys exists, the computing device 104 may be configured to transmit an activation signal to the contactless card 102 to activate the contactless card 102. Otherwise, if the computing device 104 fails to determine a match between the received contactless card activation keys and the stored device activation keys 114, the computing device 104 may prevent transmission of the activation signal to the contactless card 102, thereby keeping the contactless card 102 un-activated and/or deactivated.

In some implementations, the contactless card may include at least one of the following: a credit card, a debit card, an electronic gift card, a pre-paid credit card, a pre-paid debit card, and any combination thereof. Further, the process 200 may be executed on any device, such as, for example, a mobile telephone, a smartphone, a tablet computer, a personal digital assistant, a personal computer, a laptop, a smartwatch, and/or any other device, and/or any combination of devices.

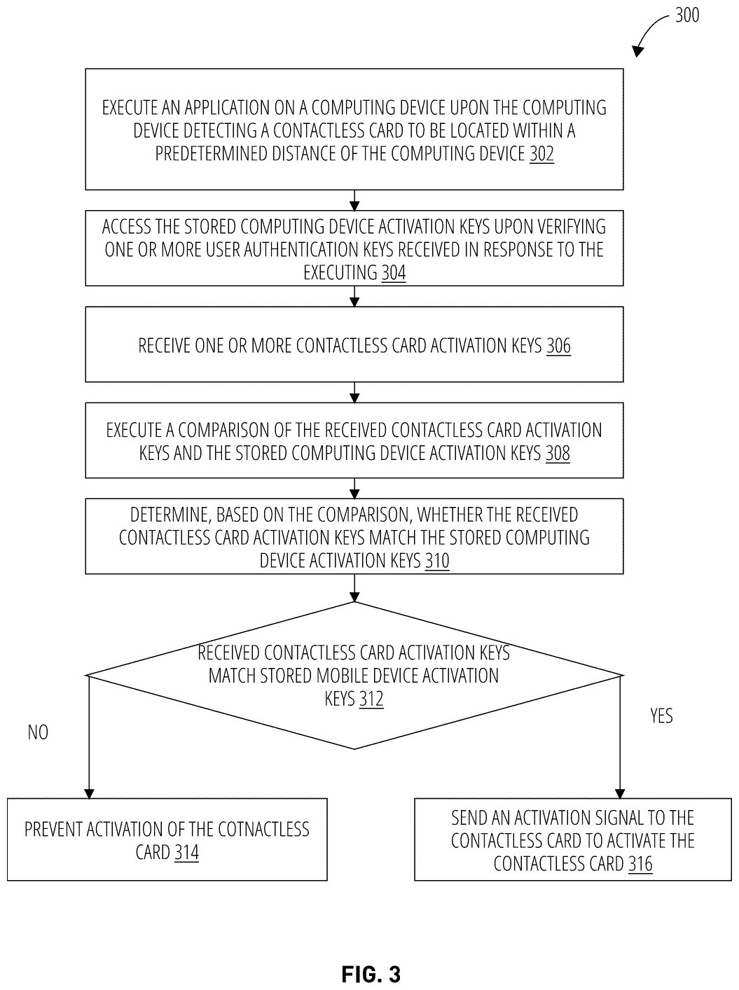

FIG. 3 illustrates another example activation process 300 for activating a contactless card, according to some implementations of the current subject matter. The process 300 may be executed by one or more components of the system 100 shown in FIGS. 1A-B. For example, the process 300 may be executed by and/or between the computing device 104 and the contactless card 102 via an NFC exchange link 108 that may be established between the card 102 and the computing device 104 upon the computing device 104 detecting the contactless card 102 entering the area 116.

Similar to the process 200 shown in FIG. 2, the process 300 may be executed in connection with activation of the contactless card 102 that may have been issued by a financial institution to a user that may have a financial account at the financial institution, which the user may be able to access using one or more authentication keys, and/or data and/or information. For instances, the authentication keys may include, but are not limited to, a facial recognition data, a fingerprint data, a biometric data, a username and a password, a multi-factor authentication token, and any combination thereof. The user may use a financial institution's mobile application opened and/or running on the computing device 104 to access the account.

Once the contactless card 102 has been issued to the user, the contactless card 102 may be manufactured and one or more contactless card activation keys may also be generated and stored on the contactless card 102 (e.g., in encrypted, unencrypted format, and/or any other format). The activation keys may also be provided to and stored on the computing device 104 as stored keys 114. The activation keys may be provided to the computing device 104 in any desired fashion, e.g., prior to activation, upon detection of user access of the mobile application, etc. The activation keys may also be stored on the server 106 and/or database 110.

At 302, and similar to operations shown and discussed in connection with FIG. 2, the computing device 104 may be configured to execute a mobile application on the computing device 104 upon the computing device 104 detecting the contactless card 102 within the area 116. Upon detecting the contactless card 102 within the area/distance 116, the computing device 104 may be configured to execute a near-field communication (NFC) exchange between the contactless card 102 and the computing device 104. The computing device 104, using the mobile application, may be configured to automatically trigger, based on the NFC exchange, generation of one or more user interfaces, which may prompt entry of one or more user authentication keys (e.g., a facial recognition data, a fingerprint data, a biometric data, a username and a password, a multi-factor authentication token, and any combination thereof).

At 304, the computing device 104 may be configured to verify user's authentication keys. The computing device 104 and/or the server 106 may be configured to execute verification of the user's authentication keys. Once verified, the computing device 104 may be configured to access the stored device activation keys 114.

At 306, the computing device 104 may receive one or more contactless card activation keys from the contactless card 102. The contactless card activation keys may be provided to the computing device 104 in any desired way, including those discussed above with regard to FIG. 2. The contactless card activation keys may be provided in an encrypted and/or unencrypted form and/or transmitted via an encrypted and/or unencrypted NFC exchange link 108. The computing device 104 may be configured to decrypt any encrypted contactless card activation keys.

At 308, the computing device 104 may be configured to execute a comparison of the received contactless card activation keys and the stored device activation keys 114. Based on the comparison, the computing device 104 may determine whether the received contactless card activation keys match the stored device activation keys 114, at 310.

If the computing device 104, at 312, determines that the received contactless card activation keys match the stored device activation keys, the computing device 104 may send an activation signal to the contactless card 102 to activate the contactless card 102, at 316. Otherwise, if, at 312, the computing device 104 determine that the received contactless card activation keys do not match the stored device activation keys 114, the computing device 104 may prevent activation of the contactless card 102, at 314.

Alternatively, or in addition, the server 106 may be configured to execute the comparison of the keys. In this case, the computing device 104 may be configured to send the received contactless card activation keys and the stored device activation keys to the server 106. The server 106 might not require the computing device 104 to send it the device activation keys, as it may use those that are stored thereon and/or in the database 110 for the purposes of activation.

If the server 106 determines that a match between the contactless card activation keys and the device activation keys and/or its own set of activation keys exists, the server 106 may be configured to transmit the activation signal to the contactless card 102 to activate the contactless card 102. Otherwise, the server 106 may be configured to prevent transmission of activation signal to the contactless card 102 (e.g., via the computing device 104).

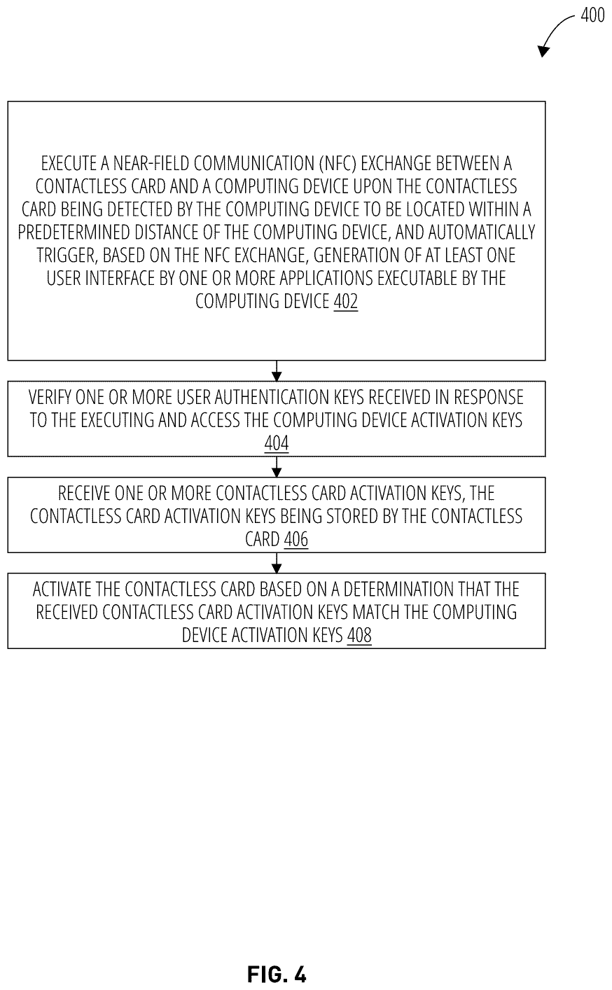

FIG. 4 illustrates yet another example activation process 400 for activating a contactless card, according to some implementations of the current subject matter. The process 400 may be executed by one or more components of the system 100 shown in FIGS. 1A-B. For example, the process 400 may be executed by and/or between the computing device 104 and the contactless card 102 via an NFC exchange link 108 that may be established between the card 102 and the computing device 104 upon the computing device 104 detecting the contactless card 102 entering the area 116.

The process 400 is similar to the processes 200 and 300 shown in FIGS. 2 and 3, respectively. The process 400 may be executed in connection with activation of the contactless card 102 issued by a financial institution to a user having a financial account therewith. The user may access such account using one or more authentication keys, and/or data and/or information (e.g., a facial recognition data, a fingerprint data, a biometric data, a username and a password, a multi-factor authentication token, and any combination thereof). A financial institution's mobile application opened and/or running on the computing device 104 may be used to access user's account.

At 402, a near-field communication (NFC) exchange link 108 may be executed and/or formed between the contactless card 102 and the computing device 104 upon the contactless card 102 being detected by the computing device 104 to be located within the predetermined distance/area 116 of the computing device 104. The NFC exchange link 108 may be executed by the computing device 104. Using the NFC exchange link 108, the computing device 104 may automatically trigger generation of at least one user interface by one or more applications (e.g., application(s) associated with the financial institution that issued the contactless card 102) executable by the computing device 104. The user interface(s) may include one or more prompts for entry of one or more user authentication keys (e.g., a facial recognition data, a fingerprint data, a biometric data, a username and a password, a multi-factor authentication token, and any combination thereof). The computing device 104 may store one or more device activation keys, as keys 114, as shown in FIGS. 1A-B. The contactless card 102 may be an inactive contactless card.

At 404, the computing device 104 may verify one or more user authentication keys that are received in response to the execution of the NFC exchange link 108. The computing device 104 may also access the device activation keys 114 that are stored on the device 104. The access to the keys 114 may be performed using the application(s) running on the computing device 104.

At 406, the computing device 104 may receive one or more contactless card activation keys that may be stored by and/or on the contactless card 102. The computing device 104 may then activate the contactless card 102 based on a determination that the received contactless card activation keys match the device activation keys 114, at 408.

FIG. 5 illustrates a data transmission system 500 according to an example embodiment. As further discussed below, system 500 may include contactless card 502, client device 504, network 506, and server 508. Although FIG. 5 illustrates single instances of the components, system 500 may include any number of components.

System 500 may include one or more contactless cards 502, which are further explained below. In some embodiments, contactless card 502 may be in wireless communication, utilizing NFC in an example, with client device 504.

System 500 may include client device 504, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Client device 504 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 504 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 504 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some examples, client device 504 of system 500 may execute one or more applications, such as software applications, that enable, for example, network communications with one or more components of system 500 and transmit and/or receive data.

The client device 504 may be in communication with one or more server(s) 508 via one or more network(s) 506 and may operate as a respective front-end to back-end pair with server 508. The client device 504 may transmit, for example from a computing device application executing on client device 504, one or more requests to server 508. The one or more requests may be associated with retrieving data from server 508. The server 508 may receive the one or more requests from client device 504. Based on the one or more requests from client device 504, server 508 may be configured to retrieve the requested data from one or more databases (not shown). Based on receipt of the requested data from the one or more databases, server 508 may be configured to transmit the received data to client device 504, the received data being responsive to one or more requests.

System 500 may include one or more networks 506. In some examples, network 506 may be one or more of a wireless network, a wired network or any combination of wireless network and wired network and may be configured to connect client device 504 to server 508. For example, network 506 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 506 may include, without limitation, telephone lines, fiber optics, IEEE Ethernet 802.3, a wide area network, a wireless personal area network, a LAN, or a global network such as the Internet. In addition, network 506 may support an Internet network, a wireless communication network, a cellular network, or the like, or any combination thereof. network 506 may further include one network, or any number of the exemplary types of networks mentioned above, operating as a stand-alone network or in cooperation with each other. network 506 may utilize one or more protocols of one or more network elements to which they are communicatively coupled. network 506 may translate to or from other protocols to one or more protocols of network devices. Although network 506 is depicted as a single network, it should be appreciated that according to one or more examples, network 506 may comprise a plurality of interconnected networks, such as, for example, the Internet, a service provider's network, a cable television network, corporate networks, such as credit card association networks, and home networks.

System 500 may include one or more servers 508. In some examples, server 508 may include one or more processors, which are coupled to memory. The server 508 may be configured as a central system, server or platform to control and call various data at different times to execute a plurality of workflow actions. Server 120 may be configured to connect to the one or more databases. The server 508 may be connected to at least one client device 504.

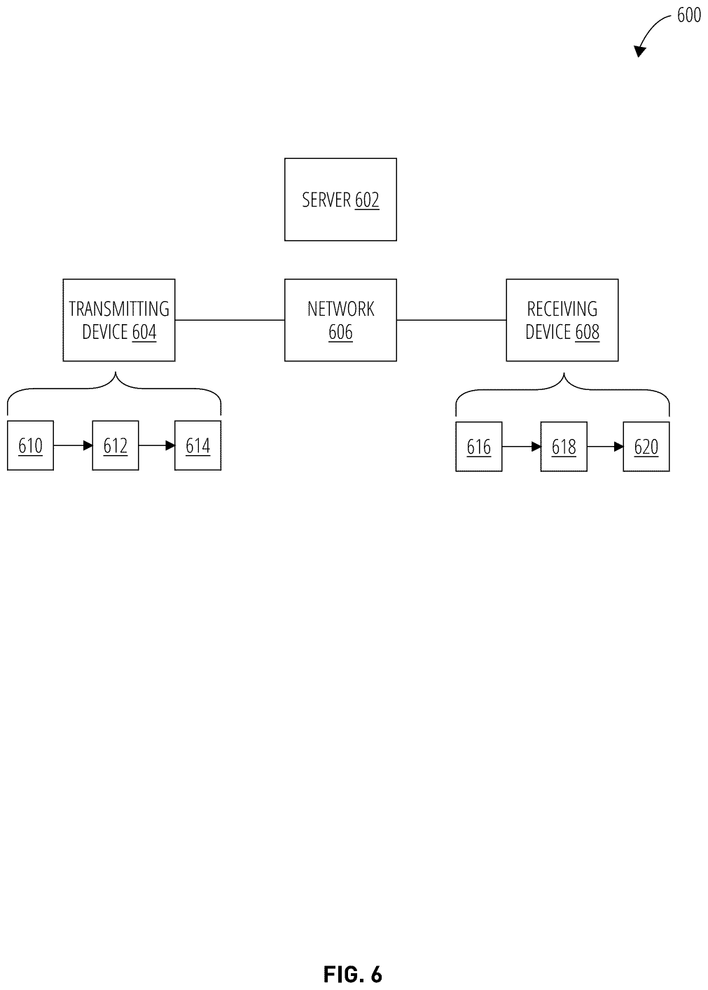

FIG. 6 illustrates a data transmission system according to an example embodiment. System 600 may include a transmitting or transmitting device 604, a receiving or receiving device 608 in communication, for example via network 606, with one or more servers 602. Transmitting device 604 may be the same as, or similar to, device 104 discussed above with reference to FIGS. 1A-B. Receiving device 608 may be the same as, or similar to, device 104 discussed above with reference to FIGS. 1A-B. Network 606 may be similar to network or link 108 discussed above with reference to FIGS. 1A-B. Server 602 may be similar to server 106 discussed above with reference to FIGS. 1A-B. Although FIG. 6 shows single instances of components of system 600, system 600 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 6, system 600 may be configured to implement key diversification. For example, a sender and recipient may desire to exchange data (e.g., original sensitive data) via respective devices 604 and 608. As explained above, although single instances of transmitting device 604 and receiving device 608 may be included, it is understood that one or more transmitting devices 604 and one or more receiving devices 608 may be involved so long as each party shares the same shared secret symmetric key. In some examples, the transmitting device 604 and receiving device 608 may be provisioned with the same master symmetric key. Further, it is understood that any party or device holding the same secret symmetric key may perform the functions of the transmitting device 604 and similarly any party holding the same secret symmetric key may perform the functions of the receiving device 608. In some examples, the symmetric key may comprise the shared secret symmetric key which is kept secret from all parties other than the transmitting device 604 and the receiving device 608 involved in exchanging the secure data. It is further understood that both the transmitting device 604 and receiving device 608 may be provided with the same master symmetric key, and further that part of the data exchanged between the transmitting device 604 and receiving device 608 comprises at least a portion of data which may be referred to as the counter value. The counter value may comprise a number that changes each time data is exchanged between the transmitting device 604 and the receiving device 608.

System 600 may include one or more networks 606. In some examples, network 606 may be one or more of a wireless network, a wired network or any combination of wireless network and wired network and may be configured to connect one or more transmitting devices 604 and one or more receiving devices 608 to server 602. For example, network 606 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 606 may include, without limitation, telephone lines, fiber optics, IEEE Ethernet 802.3, a wide area network, a wireless personal area network, a LAN, or a global network such as the Internet. In addition, network 606 may support an Internet network, a wireless communication network, a cellular network, or the like, or any combination thereof. Network 606 may further include one network, or any number of the exemplary types of networks mentioned above, operating as a stand-alone network or in cooperation with each other. Network 606 may utilize one or more protocols of one or more network elements to which they are communicatively coupled. Network 606 may translate to or from other protocols to one or more protocols of network devices. Although network 606 is depicted as a single network, it should be appreciated that according to one or more examples, network 606 may comprise a plurality of interconnected networks, such as, for example, the Internet, a service provider's network, a cable television network, corporate networks, such as credit card association networks, and home networks.

In some examples, one or more transmitting devices 604 and one or more receiving devices 608 may be configured to communicate and transmit and receive data between each other without passing through network 606. For example, communication between the one or more transmitting devices 604 and the one or more receiving devices 608 may occur via at least one of NFC, Bluetooth, RFID, Wi-Fi, and/or the like.

At block 610, when the transmitting device 604 is preparing to process the sensitive data with symmetric cryptographic operation, the sender may update a counter. In addition, the transmitting device 604 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 612, the transmitting device 604 may take the selected cryptographic algorithm, and using the master symmetric key, process the counter value. For example, the sender may select a symmetric encryption algorithm, and use a counter which updates with every conversation between the transmitting device 604 and the receiving device 608. The transmitting device 604 may then encrypt the counter value with the selected symmetric encryption algorithm using the master symmetric key, creating a diversified symmetric key.

In some examples, the counter value may not be encrypted. In these examples, the counter value may be transmitted between the transmitting device 604 and the receiving device 608 at block 612 without encryption.

At block 614, the diversified symmetric key may be used to process the sensitive data before transmitting the result to the receiving device 608. For example, the transmitting device 604 may encrypt the sensitive data using a symmetric encryption algorithm using the diversified symmetric key, with the output comprising the protected encrypted data. The transmitting device 604 may then transmit the protected encrypted data, along with the counter value, to the receiving device 608 for processing.

At block 616, the receiving device 608 may first take the counter value and then perform the same symmetric encryption using the counter value as input to the encryption, and the master symmetric key as the key for the encryption. The output of the encryption may be the same diversified symmetric key value that was created by the sender.

At block 618, the receiving device 608 may then take the protected encrypted data and using a symmetric decryption algorithm along with the diversified symmetric key, decrypt the protected encrypted data.

At block 620, as a result of the decrypting the protected encrypted data, the original sensitive data may be revealed.

The next time sensitive data needs to be sent from the sender to the recipient via respective transmitting device 604 and receiving device 608, a different counter value may be selected producing a different diversified symmetric key. By processing the counter value with the master symmetric key and same symmetric cryptographic algorithm, both the transmitting device 604 and receiving device 608 may independently produce the same diversified symmetric key. This diversified symmetric key, not the master symmetric key, is used to protect the sensitive data.

As explained above, both the transmitting device 604 and receiving device 608 each initially possess the shared master symmetric key. The shared master symmetric key is not used to encrypt the original sensitive data. Because the diversified symmetric key is independently created by both the transmitting device 604 and receiving device 608, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 604 and the receiving device 608 may be governed by symmetric requirements for how often to create a new diversification value, and therefore a new diversified symmetric key. In an embodiment, a new diversification value and therefore a new diversified symmetric key may be created for every exchange between the transmitting device 604 and receiving device 608.

In some examples, the key diversification value may comprise the counter value. Other non-limiting examples of the key diversification value include: a random nonce generated each time a new diversified key is needed, the random nonce sent from the transmitting device 604 to the receiving device 608; the full value of a counter value sent from the transmitting device 604 and the receiving device 608; a portion of a counter value sent from the transmitting device 604 and the receiving device 608; a counter independently maintained by the transmitting device 604 and the receiving device 608 but not sent between the two devices; a one-time-passcode exchanged between the transmitting device 604 and the receiving device 608; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 604 and the receiving device 608. In effect, this may create a one-time use key, such as a single-use session key.

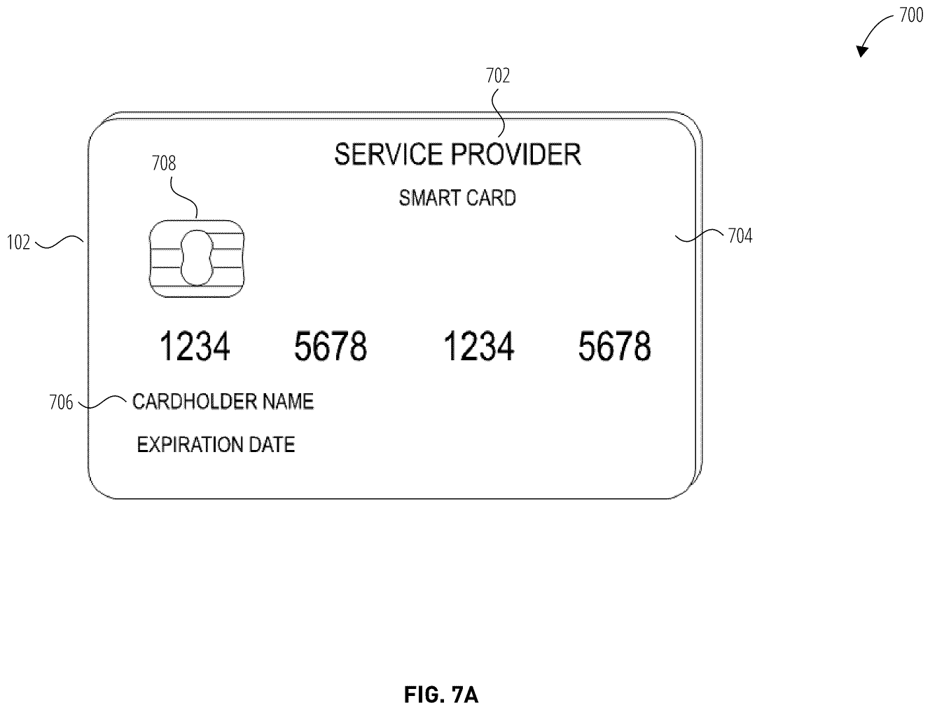

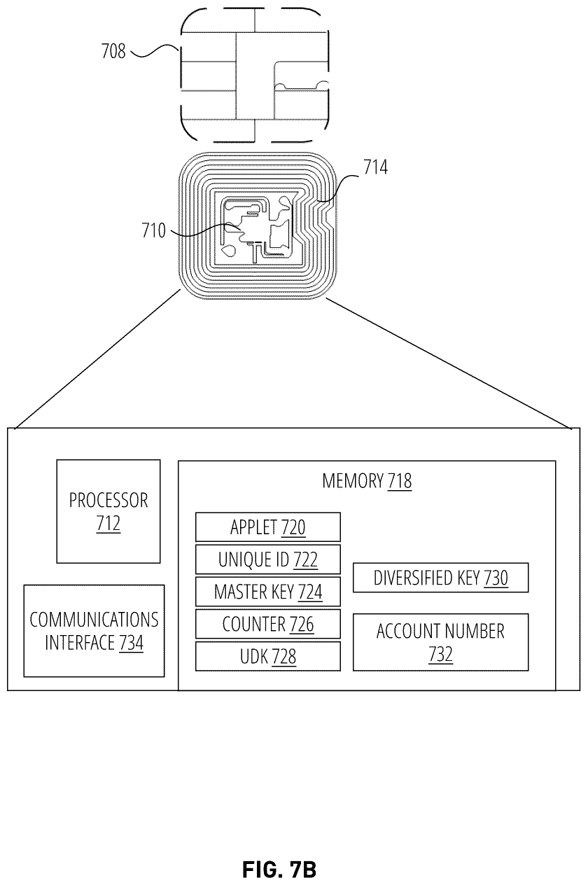

FIG. 7A is a schematic 700 illustrating an example configuration of a contactless card 102, which may include a payment card, such as a credit card, debit card, or gift card, issued by a service provider as displayed as service provider indicia 702 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 704, which may include a single layer, or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

The contactless card 102 may also include identification information 706 displayed on the front and/or back of the card, and a contact pad 708. The contact pad 708 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 7B. These components may be located behind the contact pad 708 or elsewhere on the substrate 704, e.g., within a different layer of the substrate 704, and may electrically and physically coupled with the contact pad 708. The contactless card 102 may also include a magnetic strip or tape, which may be located on the back of the card (not shown in FIG. 7A). The contactless card 102 may also include a Near-Field Communication (NFC) device coupled with an antenna capable of communicating via the NFC protocol. Embodiments are not limited in this manner.

As illustrated in FIG. 7B, the contact pad 708 of contactless card 102 may include processing circuitry 710 for storing, processing, and communicating information, including a processor 712, a memory 718, and one or more communications interface 734. It is understood that the processing circuitry 710 may contain additional components, including processors, memories, error and parity/CRC checkers, data encoders, anticollision algorithms, controllers, command decoders, security primitives and tamperproofing hardware, as necessary to perform the functions described herein.

The memory 718 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 718 may be encrypted memory utilizing an encryption algorithm executed by the processor 712 to encrypted data.

The memory 718 may be configured to store one or more applet 720, one or more counters 726, a unique ID 722, the master key 724, the UDK 728, diversified key 730, and the account number 732. The one or more applets 720 may comprise one or more software applications configured to execute on one or more contactless cards 102, such as a Java® Card applet. However, it is understood that applets 720 are not limited to Java Card applets, and instead may be any software application operable on contactless cards or other devices having limited memory. The one or more counters 726 may comprise a numeric counter sufficient to store an integer. The unique ID 722 may comprise a unique alphanumeric identifier assigned to the contactless card 102, and the identifier may distinguish the contactless card 102 from other contactless cards 102. In some examples, the unique ID 722 may identify both a customer and an account assigned to that customer.

The processor 712 and memory elements of the foregoing exemplary embodiments are described with reference to the contact pad 708, but the present disclosure is not limited thereto. It is understood that these elements may be implemented outside of the contact pad 708 or entirely separate from it, or as further elements in addition to processor 712 and memory 718 elements located within the contact pad 708.

In some examples, the contactless card 102 may comprise one or more antenna(s) 714. The one or more antenna(s) 714 may be placed within the contactless card 102 and around the processing circuitry 710 of the contact pad 708. For example, the one or more antenna(s) 714 may be integral with the processing circuitry 710 and the one or more antenna(s) 714 may be used with an external booster coil. As another example, the one or more antenna(s) 714 may be external to the contact pad 708 and the processing circuitry 710.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the power connection of the contactless card 102, which may be functionally maintained through one or more capacitors. The contactless card 102 may communicate back by switching a load on the coil of the contactless card 102 or load modulation. Load modulation may be detected in the terminal's coil through interference. More generally, using the antenna(s) 714, processor 712, and/or the memory 718, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet 720 may be added to contactless cards to provide a one-time password (OTP) for multifactor authentication (MFA) in various mobile application-based use cases. Applet 720 may be configured to respond to one or more requests, such as near field data exchange requests, from a reader, such as a mobile NFC reader (e.g., of a mobile computing device 104 or point-of-sale terminal) and produce an NDEF message that comprises a cryptographically secure OTP encoded as an NDEF text tag. The NDEF message may include a cryptogram, and any other data.

One example of an NDEF OTP is an NDEF short-record layout (SR=1). In such an example, one or more applets 720 may be configured to encode the OTP as an NDEF type 4 well known type text tag. In some examples, NDEF messages may comprise one or more records. The applet 720 may be configured to add one or more static tag records in addition to the OTP record.

In some examples, the one or more applets 720 may be configured to emulate an RFID tag. The RFID tag may include one or more polymorphic tags. In some examples, each time the tag is read, different cryptographic data is presented that may indicate the authenticity of the contactless card. Based on the one or more applets 720, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter 726 may be configured to increment. In some examples, each time data from the contactless card 102 is read (e.g., by a mobile device), the counter 726 is transmitted to the server for validation and determines whether the counter 726 are equal (as part of the validation) to a counter of the server.

The one or more counter 726 may be configured to prevent a replay attack. For example, if a cryptogram has been obtained and replayed, that cryptogram is immediately rejected if the counter 726 has been read or used or otherwise passed over. If the counter 726 has not been used, it may be replayed. In some examples, the counter that is incremented on the contactless card 102 is different from the counter that is incremented for transactions. The contactless card 102 is unable to determine the application transaction counter 726 since there is no communication between applets 720 on the contactless card 102. In some examples, the contactless card 102 may comprise a first applet 720-1, which may be a transaction applet, and a second applet 720-2. Each applet 720-1 and 720-2 may comprise a respective counter 726.

In some examples, the counter 726 may get out of sync. In some examples, to account for accidental reads that initiate transactions, such as reading at an angle, the counter 726 may increment but the application does not process the counter 726. In some examples, when the computing device 104 is woken up, NFC may be enabled and the computing device 104 may be configured to read available tags, but no action is taken responsive to the reads.

To keep the counter 726 in sync, an application, such as a background application, may be executed that would be configured to detect when the computing device 104 wakes up and synchronize with the server of a banking system indicating that a read that occurred due to detection to then move the counter 726 forward. In other examples, Hashed One Time Password may be utilized such that a window of mis-synchronization may be accepted. For example, if within a threshold of 10, the counter 726 may be configured to move forward. But if within a different threshold number, for example within 10 or 20, a request for performing re-synchronization may be processed which requests via one or more applications that the user tap, gesture, or otherwise indicate one or more times via the user's device. If the counter 726 increases in the appropriate sequence, then it possible to know that the user has done so.

The key diversification technique described herein with reference to the counter 726, master key 724, UDK 728, and diversified key 730, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV, and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys (e.g., the UDKs 728) and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

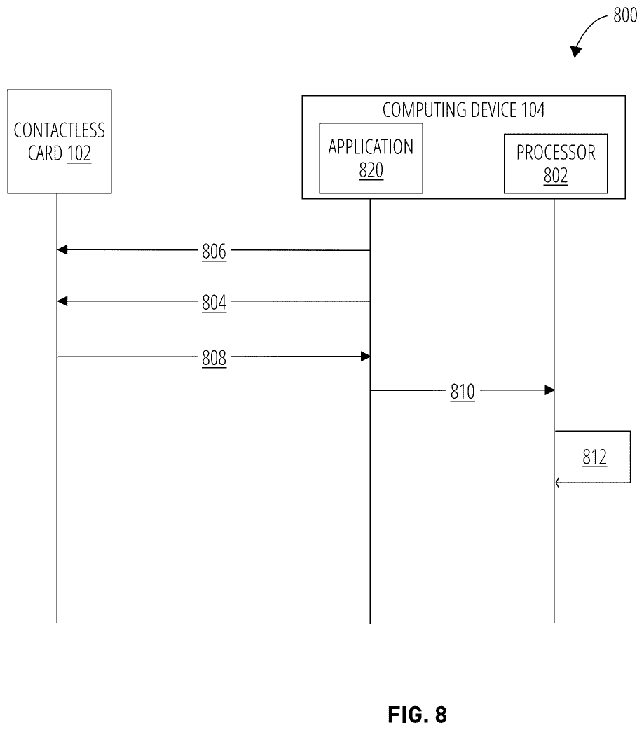

FIG. 8 is a timing diagram illustrating an example sequence for providing authenticated access according to one or more embodiments of the present disclosure. Sequence flow 800 may include contactless card 102 and computing device 104, which may include an application 820 and processor 802. The application 820 can be any of the applications that execute on the computing device 104.

At line 806, the application 820 communicates with the contactless card 102 (e.g., after being brought near the contactless card 102). Communication between the application 820 and the contactless card 102 may involve the contactless card 102 being sufficiently close to a card reader (not shown) of the computing device 104 to enable NFC data transfer between the application 820 and the contactless card 102.

At line 804, after communication has been established between computing device 104 and contactless card 102, contactless card 102 generates a message authentication code (MAC) cryptogram. In some examples, this may occur when the contactless card 102 is read by the application 820. In particular, this may occur upon a read, such as an NFC read, of a near field data exchange (NDEF) tag, which may be created in accordance with the NFC Data Exchange Format. For example, a reader application, such as application 820, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 820 may be configured to transmit a request to contactless card 102, the request comprising an instruction to generate a MAC cryptogram.

At line 808, the contactless card 102 sends the MAC cryptogram to the application 820. In some examples, the transmission of the MAC cryptogram occurs via NFC, however, the present disclosure is not limited thereto. In other examples, this communication may occur via Bluetooth, Wi-Fi, or other means of wireless data communication. At line 810, the application 820 communicates the MAC cryptogram to the processor 802.

At line 812, the computing device 104, using a processor 802, verifies the MAC cryptogram pursuant to an instruction from the application 820. For example, the MAC cryptogram may be verified, as explained below. In some examples, verifying the MAC cryptogram may be performed by a device other than computing device 104, such as the server 106. For example, processor 802 may output the MAC cryptogram for transmission to the server 106, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

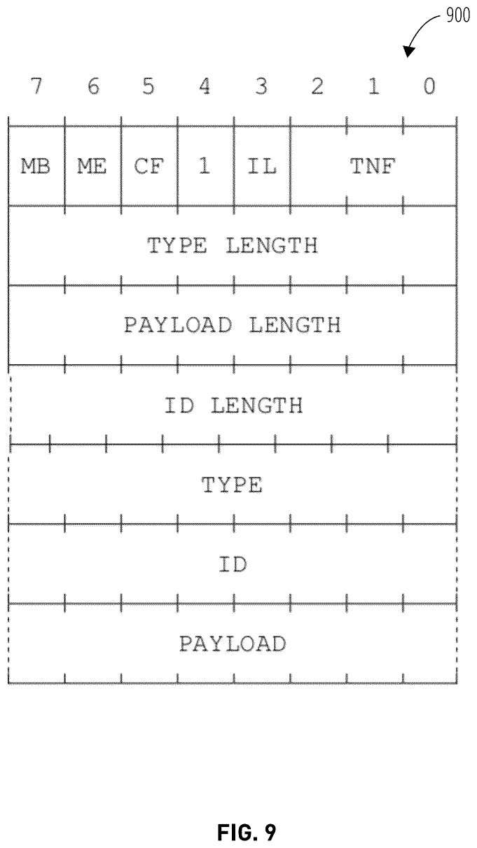

FIG. 9 illustrates an NDEF short-record layout (SR=1) data structure 900 according to an example embodiment. One or more applets 720 may be configured to encode an OTP as an NDEF type 4 well known type text tag. In some examples, NDEF messages may comprise one or more records. The applets may be configured to add one or more static tag records in addition to the OTP record. Exemplary tags include, without limitation, Tag type: well-known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 900 may include a cryptogram and any other data provided by the applet 720.

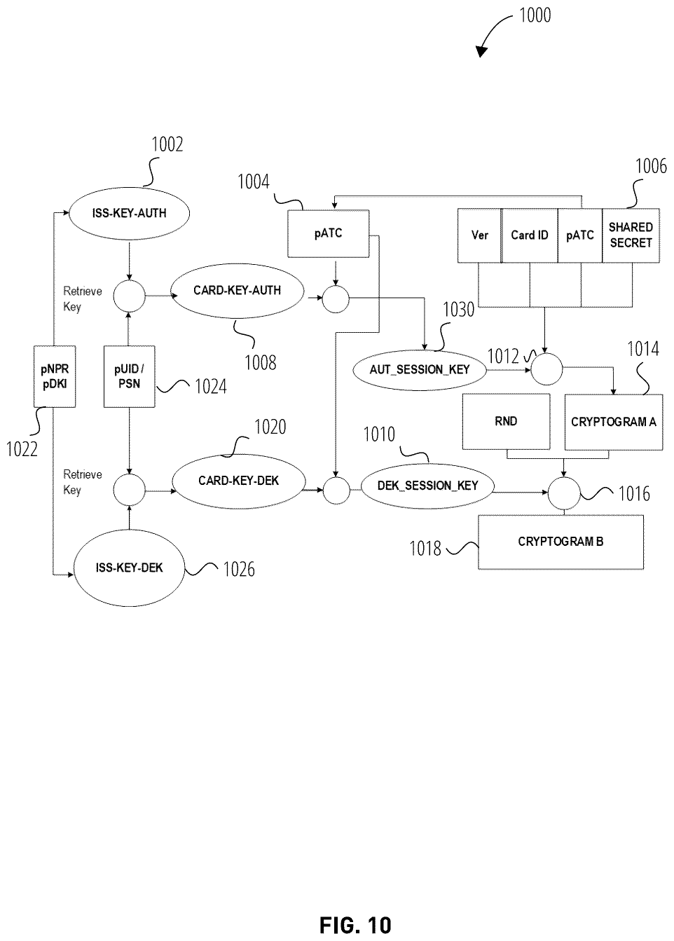

FIG. 10 illustrates a diagram of a system 1000 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV, and it is implemented by hardware in the contactless card. By using a key diversification process, one or more keys may be derived from a master key based upon uniquely identifiable information for each entity that requires a key.

Regarding master key management, two issuer master keys 1002, 1026 may be required for each part of the portfolio on which the one or more applets is issued. For example, the first master key 1002 may comprise an Issuer Cryptogram Generation/Authentication Key (Iss-Key-Auth) and the second master key 1026 may comprise an Issuer Data Encryption Key (Iss-Key-DEK). As further explained herein, two issuer master keys 1002, 1026 are diversified into card master keys 1008, 1020, which are unique for each card. In some examples, a network profile record ID (pNPR) 522 and derivation key index (pDKI) 1024, as back-office data, may be used to identify which Issuer Master Keys 1002, 1026 to use in the cryptographic processes for authentication. The system performing the authentication may be configured to retrieve values of pNPR 1022 and pDKI 1024 for a contactless card at the time of authentication.

In some instances, the issuer master keys 1002, 1026 may not be stored on the card but may be utilized at the time of manufacture of provisioning of the card to generate the card master keys 1008, 1020. The card master keys 1008, 1020 may be securely provisioned and stored on the contactless card. As discussed below, the card master keys 1008, 1020 are then utilized to generate diversified session keys 1030, 1010.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1008 and Card-Key-Dek 1020). The session keys (Aut-Session-Key 1030 and DEK-Session-Key 1010) may be generated by the one or more applets and derived by using the application transaction counter (pATC) 1004 with one or more algorithms. To fit data into the one or more algorithms, only the 2 low order bytes of the 4-byte pATC 1004 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 1004 counter. At each tap of the contactless card 102, pATC 1004 is configured to be updated, and the card master keys Card-Key-AUTH 508 and Card-Key-DEK 1020 are further diversified into the session keys Aut-Session-Key 1030 and DEK-Session-KEY 1010. pATC 1004 may be initialized to zero at personalization or applet initialization time. In some examples, the pATC counter 1004 may be initialized at or before personalization and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1030. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1030, as explained above. As explained above, the low order two bytes of the counter may be used to diversify for the one or more MAC session keys. As explained below, AUT-Session-Key 1030 may be used to MAC data 1006, and the resulting data or cryptogram A 1014 and random number RND may be encrypted using DEK-Session-Key 1010 to create cryptogram B or output 1018 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1010 derived from the Card-Key-DEK 1020. In this case, the ATC value for the session key derivation is the least significant byte of the counter pATC 1004.

The format below represents a binary version example embodiment. Further, in some examples, the first byte may be set to ASCII ‘A’.

| Message Format | | | | |
|---|---|---|---|---|
| 1 | 2 | 4 | 8 | 8 |
| 0x43 (Message Type ‘A’) | Version | pATC | RND | Cryptogram A (MAC) |
| Cryptogram A (MAC) | 8 bytes | | | |
| MAC of | | | | |
| 2 | 8 | 4 | 4 | 18 bytes input data |
| Version | pUID | pATC | Shared Secret | |

| Message Format | | | | |
|---|---|---|---|---|
| 1 | 2 | 4 | | 16 |
| 0x43 (Message Type ‘A’) | Version | pATC | | Cryptogram B |
| Cryptogram A (MAC) | 8 bytes | | | |
| MAC of | | | | |
| 2 | 8 | 4 | 4 | 18 bytes input data |
| Version | pUID | pATC | Shared Secret | |
| Cryptogram B | 16 | | | |
| Sym Encryption of | | | | |
| 8 | 8 | | | |
| RND | Cryptogram A | | | |

Another exemplary format is shown below. In this example, the tag may be encoded in hexadecimal format.

| Message Format | | | | |
|---|---|---|---|---|
| 2 | 8 | 4 | 8 | 8 |
| Version | pUID | pATC | RND | Cryptogram A (MAC) |
| 8 bytes | | | | |
| 8 | 8 | 4 | 4 | 18 bytes input data |
| pUID | pUID | pATC | Shared Secret | |

| Message Format | | | | |
|---|---|---|---|---|
| 2 | 8 | 4 | | 16 |
| Version | pUID | pATC | | Cryptogram B |
| 8 bytes | | | | |
| 8 | | 4 | 4 | 18 bytes input data |
| pUID | pUID | pATC | Shared Secret | |
| Cryptogram B | 16 | | | |
| Sym Encryption of | | | | |
| 8 | 8 | | | |
| RND | Cryptogram A | | | |

The UID field of the received message may be extracted to derive, from master keys Iss-Key-AUTH 502 and Iss-Key-DEK 1026, the card master keys (Card-Key-Auth 1008 and Card-Key-DEK 1020) for that particular card. Using the card master keys (Card-Key-Auth 508 and Card-Key-DEK 1020), the counter (pATC) field of the received message may be used to derive the session keys (Aut-Session-Key 1030 and DEK-Session-Key 1010) for that particular card. Cryptogram B 1018 may be decrypted using the DEK-Session-KEY, which yields cryptogram A 1014 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 1014, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1030. The input data 1006 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1012, data 1006 is processed through the MAC using Aut-Session-Key 1030 to produce MAC output (cryptogram A) 1014, which is encrypted.

In order to provide additional protection against brute force attacks exposing the keys on the card, it is desirable that the MAC cryptogram 1014 be enciphered. In some examples, data or cryptogram A 1014 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1010. In the encryption operation 1016, data or cryptogram A 1014 and RND are processed using DEK-Session-Key 510 to produce encrypted data, cryptogram B 1018. The data 1014 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

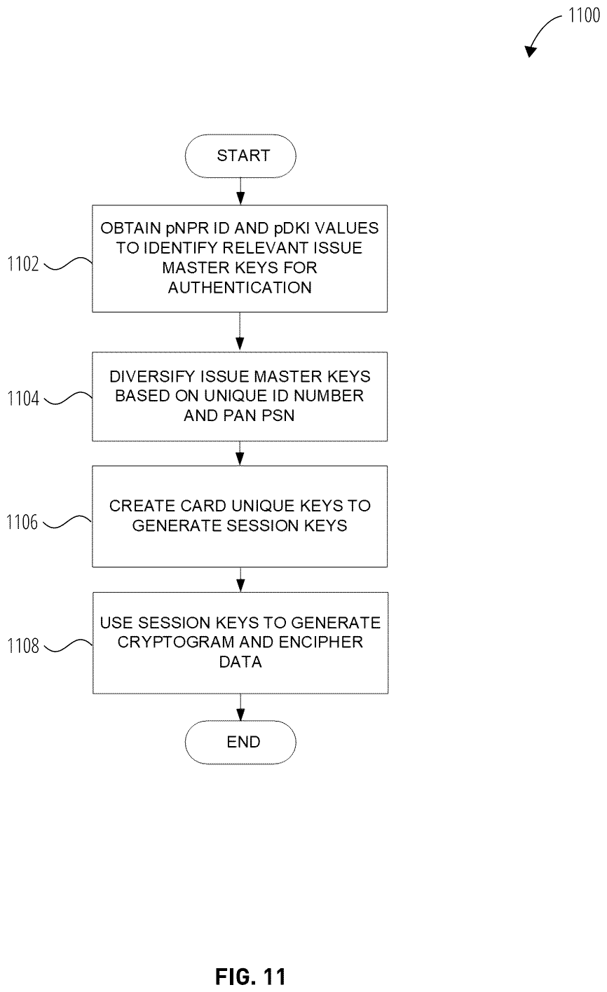

FIG. 11 illustrates a method 1100 for generating a cryptogram. For example, at block 1102, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 1104, Issuer Master Keys may be diversified by combining them with the card's unique ID number (pUID) and the PAN sequence number (PSN) of one or more applets, for example, a payment applet.

At block 1106, Card-Key-Auth and Card-Key-DEK (unique card keys) may be created by diversifying the Issuer Master Keys to generate session keys which may be used to generate a MAC cryptogram.

At block 1108, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

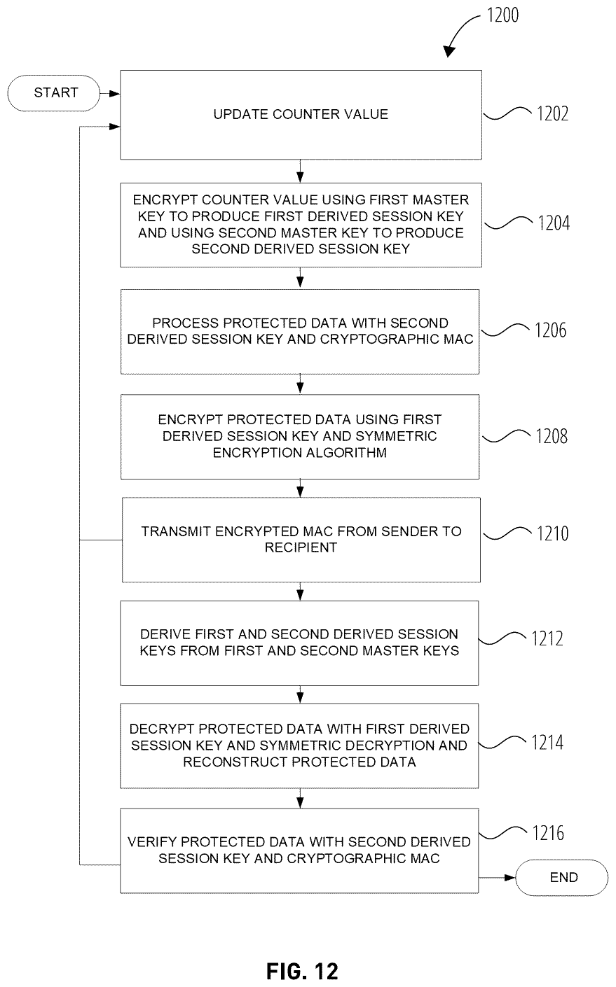

FIG. 12 depicts an exemplary process 1200 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 1202, and other data, such as data to be protected, which it may secure share with the recipient.

At block 1204, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1206, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1208, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 1210, the encrypted MAC is transmitted, from the sender to the recipient, with sufficient information to identify additional secret information (such as shared secret, master keys, etc.), for verification of the cryptogram.

At block 1212, the recipient uses the received counter value to independently derive the two derived session keys from the two master keys as explained above.

At block 1214, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1216, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1202) and a new set of session keys may be created (at block 1210). In some examples, the combined random data may be discarded.

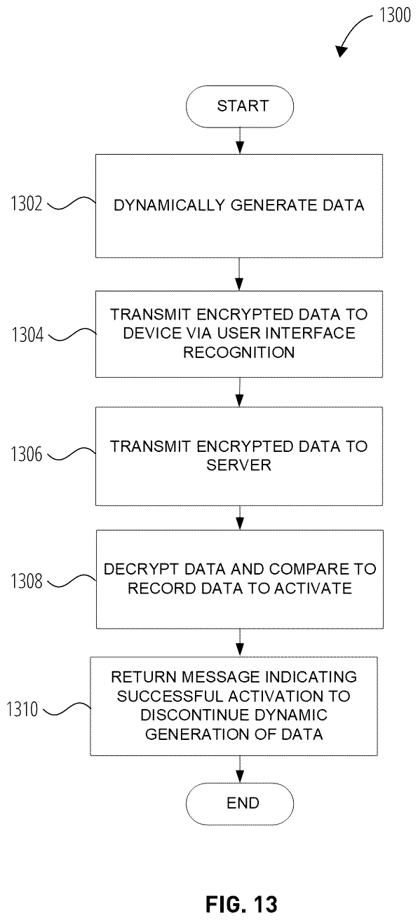

FIG. 13 illustrates a method 1300 for card activation according to an example embodiment. For example, card activation may be completed by a system including a card, a device, and one or more servers. The contactless card, device, and one or more servers may reference same or similar components that were previously explained, such as contactless card 102, computing device 104, and server 106.

In block 1302, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1304, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1306, the one or more portions of the data may be communicated to one or more servers, such as a card issuer server. For example, one or more encrypted portions of the data may be transmitted from the device to the card issuer server for activation of the card.

In block 1308, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1310, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

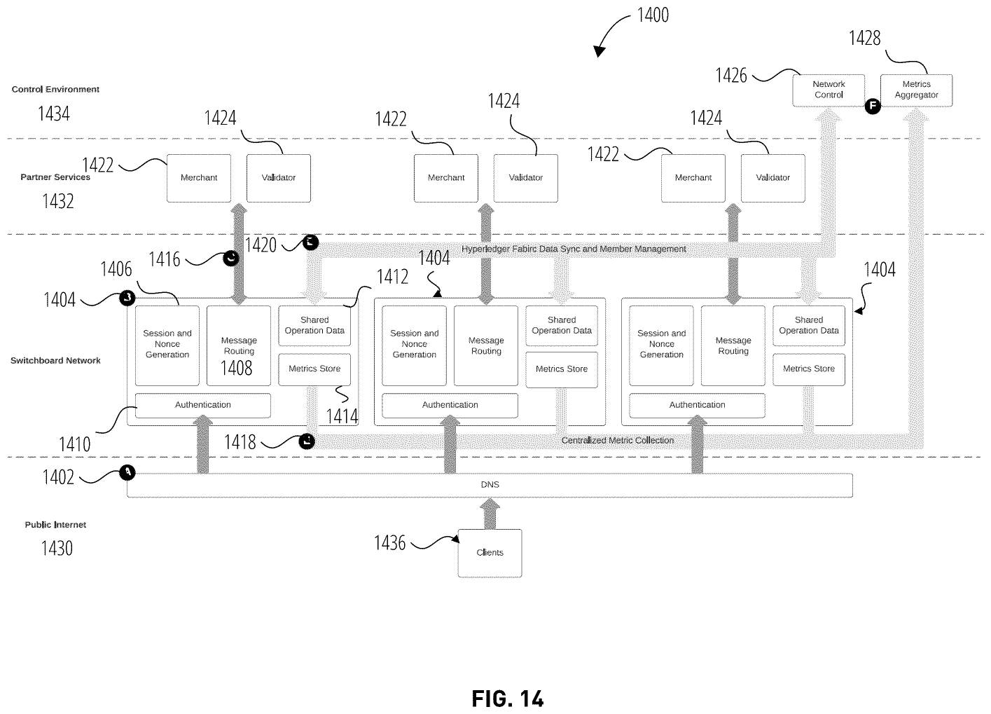

FIG. 14 illustrates an example of system 1400 in accordance with the embodiments discussed herein. The system 1400 includes additional devices and systems configured to enable contactless card issuers to tap-to-card services in a distributed environment. Specifically, system 1400 enables any number of card issuer systems to provide card services including authentication to their clients through a switching fabric, i.e., the switchboard system, in a secure and safe manner.

In embodiments, the system 1400 includes one or more nodes 1404 configured to perform routing operations. Each switchboard node 1404 may include a session and nonce generator 1406, a message router 1408, authentication 1410 module, an operation data 1412 store, and a metrics store 1414. Further, each of the nodes may be configured the same and share configurations, but each switchboard node 1404 may independently process and route messages and requests to the appropriate systems, such as the merchant (authenticator) systems and issuer systems. Each of the nodes 1404 is configured to act as a broker of trust between an issuer system, the merchant system 1422, and/or validation system 1424, for example. Each switchboard node 1404 is configured to route each message to the correct issuer system while maintaining data security. For example, a switchboard node 1404 may route a message between an issuer system and merchant system while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 1404. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 1404 may operate in a cloud-based computing environment, e.g., a collection of hardware, software, and networking components that enable the delivery of cloud computing services. The switchboard nodes 1404 and the computing services are delivered over the Internet, and they can be accessed from anywhere in the world with an Internet connection. In embodiments, a client 1436 may access a switchboard node 1404 through Domain Name System 1402 or domain name system (DNS). The DNS 1402 a hierarchical and distributed naming system for computers, services, and other resources connected to the Internet or other networks. It associates various information with domain names assigned to each registered participant. In one example, the DNS 1402 may translate a name known to software executing on a client 1436 to route data to one or more of switchboard node 1404 of the switchboard system. In embodiments, the DNS 1402 may generate into a number, such as an Internet Protocol (IP) address, an address record (A-record), or another Host name (C-name record). At a high level, the Domain Name System 1402 translates known domain names to numerical Internet Protocol (IP) addresses needed for locating and identifying computer services and devices with the underlying network protocols. Clients use the global DNS system to select the best node to use.

In embodiments, a client 1436 communicates with the switchboard system to perform one or more of the partner services 1432, such as conducting a transaction with a merchant, validate the customer, or other tap-to functions. Once the client 1436 identifies a switchboard node 1404 and resolves an address to communicate with the switchboard node 1404, the client 1436 may send one or more messages to the switchboard node 1404 to authenticate and perform the operation. The switchboard node 1404 includes an authentication 1410 function that is configured to authenticate the client 1436. In embodiments, the client 1436 sends a message or authorization request to the switchboard node 1404 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client ID | Individual identifier of client |
| GReyx5BuEAaE72bWbFZJfHRL8Dbt1Uum | Client Key | Randomly assigned key |

The switchboard node 1404 may authorize or authenticate the client 1436 or user, and the switchboard node 1404 may utilize the additional components, such as the session and nonce generator 1406 and message router 1408, to perform the operations. Note the validators or validation systems 1424 never interact with the merchant systems 1422, nor vice versa. The nodes 1404 brokers all communication.

In some embodiments, the switchboard system may utilize a hyperledger fabric 1420 to manage synchronizing the shared operation data 1412 and member management across the network. The hyperledger fabric 1420 is distributed ledger framework having a permissioned network model that only authorized participants can join the network and access the data that is stored on a ledger.

In embodiments, the hyperledger fabric 1420 may be generated by creating one or more set of peers, an ordering service, and a channel. Once the network is created, the system 1400 deploys chaincode to the network or nodes 1404 permitted to access the fabric. The chaincode is the code that runs on the blockchain and executes the network control 1426 and operation data 1412 logic code. Once the chaincode is deployed, each of the switchboard nodes 1404 is configured to invoke transactions on the blockchain to add data to the blockchain, e.g., the operational data. A switchboard node 1404 or another device can query the ledger to retrieve data. The ledger is a distributed database that stores all of the data that has been added to the blockchain.

All nodes 1404 keep an independently verifiable log of their actions that can be transmitted to a centralized aggregator to build a picture of overall network usage. At a central level, system 1400 can manage network operation data and management and have a centralized view of network use, aggregated and abstracted to the appropriate level.

In accordance with embodiments discussed herein, the system 1400 enables any number of contactless card issuers to provide contactless cards 102 to their customers. The customers may utilize their contactless cards 102 to authenticate themselves to post messages on a social media site, for example. System 1400 may route data, e.g., a cryptogram, encrypted data, signed data, etc. from a contactless card 102 through the client 1436 to the appropriate authenticator or validator, e.g., partner services 1432 and/or validation system 1424. The data may be authenticated, and result may be returned to the correct server to enable an operation to be performed, e.g., posting an authenticated post on a social media site.

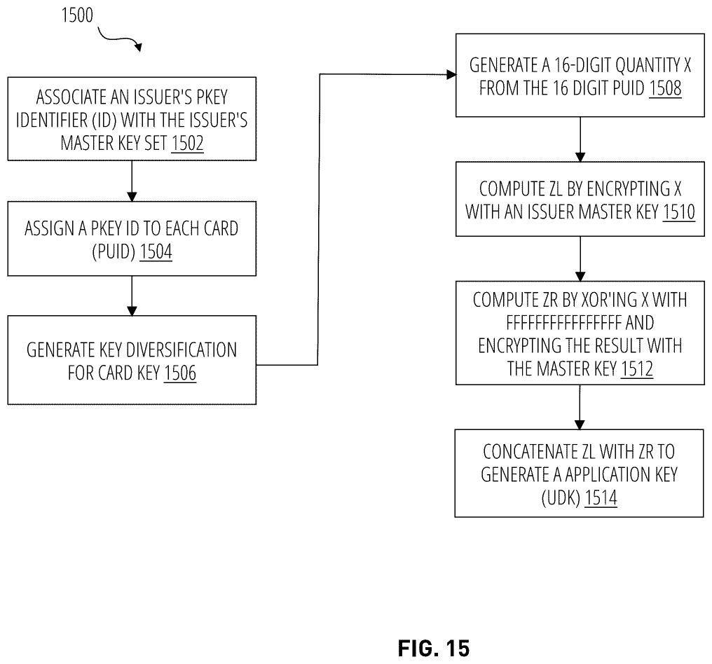

In a multi-issuer distributed environment, each issuer may be associated with and generate their own master keys that may be used to further generate card master keys for each card issued. The flows discussed in FIG. 15 through FIG. 19 may be performed to generate encrypted data that may be properly routed through system 1400 to perform authentication techniques. These flows may be different than flows discussed in FIG. 10 through FIG. 13, which are generally performed in a single card issuer environment. Embodiments are not limited in this manner.

FIG. 15 illustrates flow 1500, an example of operations to identify the issuer's master keys and generate unique card master keys or application keys. In some instances, these operations may be performed off the card, at personalization time, and then stored in a memory of the card. Further, the issuer's master key(s) may be utilized to generate card master keys. The card master keys may be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, these one or more of the operations may be performed on card, e.g., at the time of manufacturer, each time an operation is performed with a key, and so forth.

At block 1502, embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the operations discussed in blocks block 1504 to block 1514.

At block 1504, the system assigns a pKey ID to a card or pUID, a card application's unique 16-decimal digital identify. At block 1506, the system initiates generating a card's UDK(s). At block 1508, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

At block 1510, the system computes or calculates (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

At block 1512, the system calculates or computes ZR is by XOR'ing X with FFFFFFFFFFFFFFFF and encrypting the result with an issuer master key. Again, an encryption algorithm such as DES, AES, RSA, etc, may be used to encrypt the result of the XOR'ing. At block 1514, the system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys.

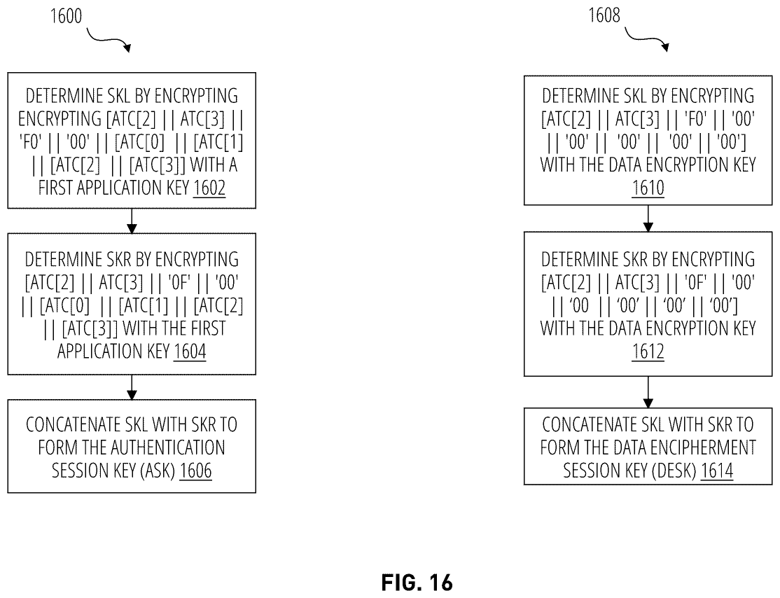

FIG. 16 illustrates a first flow 1600 to generate a unique cryptogram session key (ASK) and a second flow 1608 to generate a unique encipherment session key (DESK) in accordance embodiments. The operations discussed in flow 1600 and flow 1608 may be performed on the contactless card.

At block 1602, the contactless card including circuitry compute SKL by encrypting [ATC[2]∥ATC[3]∥‘F0’∥‘00’∥[ATC[0]∥[ATC[1]∥[ATC[2]∥[ATC[3]] with an application key, e.g., the key generated in flow 1500. Further, at block 1604 the contactless card compute SKR by encrypting [ATC[2]∥ATC[3]∥‘0F’∥‘00’∥[ATC[0]∥[ATC[1]∥[ATC[2]∥[ATC[3]] with the application key. Finally, and at block 1606, the contactless card concatenates SKL with SKR to form an authentication session key (ASK). In embodiments, the ASK is used to perform operations utilizing the contactless card, such as encrypting the cryptographic MAC.

In embodiments, a card applet also supports session key derivation to generate a unique encipherment session key DESK as shown in flow 1608. At block 1610, the contactless card including circuitry Compute SKL by encrypting [ATC[2]∥ATC[3]∥‘00’∥‘00’∥‘00’∥‘00’∥‘00’] with the Data Encryption Key (DEK) Further and at block 1612, the contactless card computes SKR by encrypting [ATC[2]∥ATC[3]∥‘0F’∥‘00’∥‘00∥‘00’∥‘00’∥‘00’] with the Data Encryption Key At block 1614, the contactless card concatenate SKL with SKR to form the Data Encipherment Session Key.

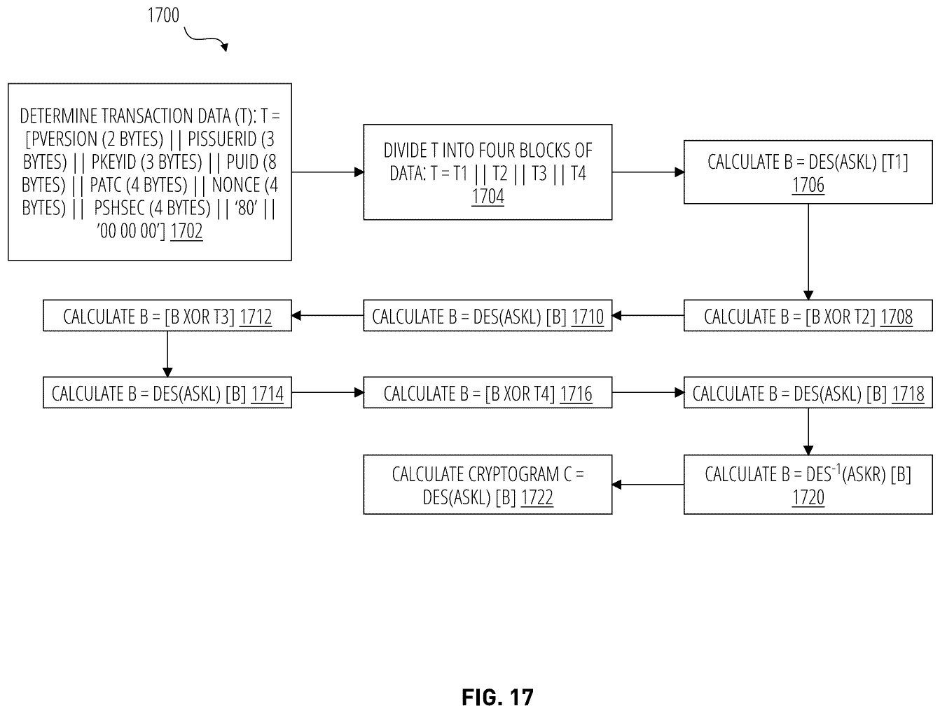

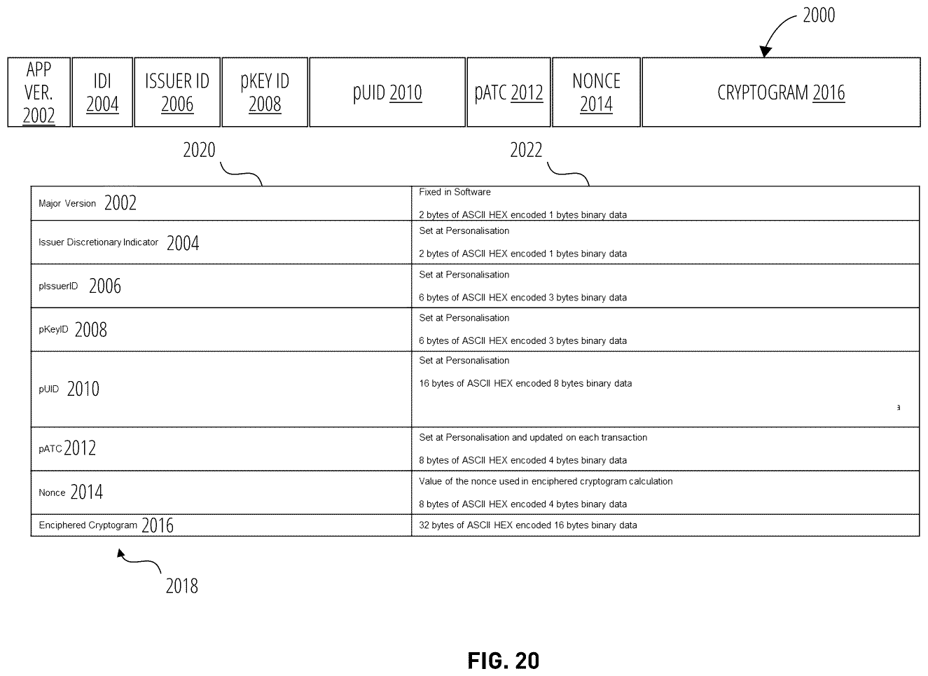

FIG. 17 illustrates an example flow 1700 that may be performed by a contactless card or circuitry thereon to generate a cryptogram to perform operations discussed herein, e.g., see FIG. 20, message 2000. The cryptogram C is determined by calculating a MAC over the 32-byte transaction data T using the Authentication Session Key (ASK).

At block 1702, the contactless card including circuitry computes T=[pVersion (2 bytes)∥pIssucrID (3 bytes)∥pKeyID (3 bytes)∥pUID (8 bytes)∥pATC (4 bytes)∥nonce (4 bytes)∥pSHSEC (4 bytes)∥‘80’∥‘00 00 00’]. In one example, the pVersion is an applet version number, the pIssuerID is an issuer identifier, the pKeyID includes data that identifies a set of master keys for a card issuer of the contactless card, the pUID is a card unique identifier assigned to the contactless card, the pATC is a card's counter value, the nonce is the nonce provided during communication with another device as described herein, and the pSHSEC is value to indicate adherence to Secure Hardware Security Evaluation Criteria.

The contactless card may process the data to generate the cryptogram. At block 1704, the contactless card divides T into four blocks of 8 bytes of data: T=T1∥T2∥T3∥T4. At block 1706, the contactless card computes B=DES(ASKL) [T1], where is the Data Encryption Standard or another symmetric encryption algorithm, ASKL is a portion of the ASK, e.g., the “left” half of the key. At block 1708, the contactless card computes B=[B XOR T2], and at block 1710, the contactless card computes B=DES(ASKL) [B], where DES is an encryption algorithm. At block 1712, the contactless card computes B=[B XOR T3], and at block 1714, the contactless card computes B=DES(ASKL) [B]. At block 1716, the contactless card computes B=[B XOR T4] and at block 1718 the contactless card computes B=DES(ASKL) [B]. At block 1720, the contactless card compute B=DES⁻¹ (ASKR) [B], where DES⁻¹ is the reciprocal DES operation and ASKR is a portion of the ASK, e.g., the right half. At block 1722, the contactless card computes the cryptogram C=DES(ASKL) [B].

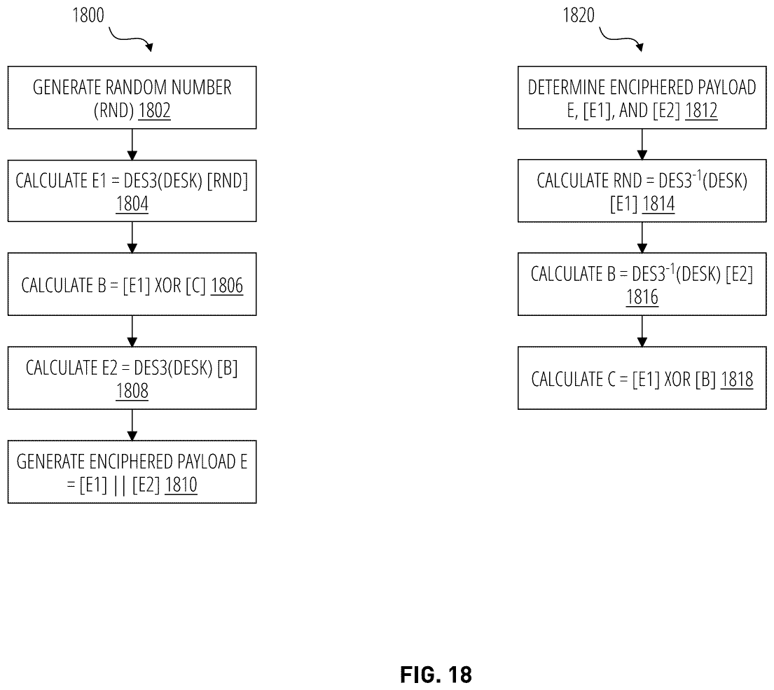

In embodiments, a contactless card may encipher the cryptogram to secure the data further. FIG. 18 illustrates an example flow 1800 to encipher the cryptogram with the Data Encipherment Session Key (DESK) (FIG. 16, flow 1608) being used to encrypt in Cipher Block Chaining mode (CBC).

At block 1802, a contactless card including circuitry is configured to generate an 8-byte random number [RND]. At block 1804, the contactless card computes E1=DES3(DESK) [RND], where DES3 is a symmetric encryption algorithm such as the Triple Data Encryption Standard. At block 1806, the contactless card computes B=[E1] XOR [C], where C is the cryptogram generated in flow 1700. The contactless card computes E2=DES3(DESK) [B] at block 1808, where B is computed above in FIG. 17, flow 1700. At block 1810 the contactless card generates the 16-byte enciphered payload E=[E1]∥[E2].

In embodiments, a device or the contactless card my decrypt the payload E in accordance with flow 1820. At block 1812, a device determines or retrieves the payload E. At block 1814, the device computes a RND=DES3⁻¹ (DESK) [E1]. At block 1816, the device determines B=DES3⁻¹ (DESK) [E2], and at block 1818, the device computes C=[E1] XOR [B].

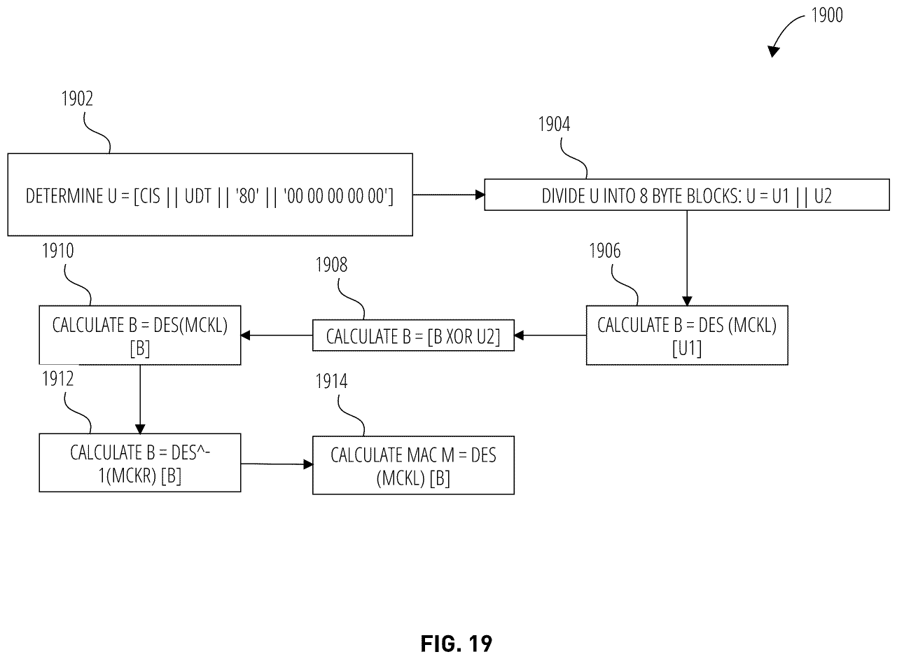

FIG. 19 illustrates an example flow 1900 for calculate a message authentication code (MAC). The operations of flow 1900 by circuitry of the contactless card. In some instances, the MAC may be an updated MAC. In embodiments, the updated MAC is included in data communicated from a contactless card to another device, such as a mobile device, point-of-sale (POS) terminal, or any other type of computer. In one example, the update MAC may be included in an NDEF message.

In embodiments, the updated MAC may be calculated to protect the control indicators and include updated date/time. For example, the update MAC M is determined by calculating a MAC over the 10 bytes of the update data U with the Update MAC Card Key (MCK) as follows.

At block 1902, embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, at block 1904, data U is broken into two blocks of 8 bytes of data, where U=U₁∥U₂. Further, operations may be performed on U₁ and U₂.

At block 1906 embodiments include applying an algorithm to the first portion (U₁) of the data. In one example, a result B may be computed where B=DES(MCKL) [U₁], where DES is a Data Encryption Standard algorithm using a first portion (L) of the MAC Card Key (MCKL).

At block 1908 an additional operation may be performed on the result B. Specifically, the result B may be exclusively or'd (XOR) with a second portion of the data (U₂).

The updated result B may be further processed at block 1910. For example, result B may be further processed by applying the DES algorithm using MCKL again to B. The result B of block 1910 may further be processed at block 1912. Specifically, the result B may be processed by the inverse DES with a second portion (R) of the MCK (MCKR). And at block 1914, the MAC M may be determined by applying the DES algorithm with the MCKL to result B of block 1912.

FIG. 20 illustrates an example of a message 2000 that may be communicated by a contactless card to perform the functions described herein. One or more of the fields in message 2000 may also be utilized to route the message 2000 through the switchboard system and perform authentication/validation techniques.

In embodiments, the message 2000 includes an applet version 2002 field, an issuer discretionary indicator 2004 field, an Issuer Identifier 2006 field, a pKey ID 2008 field, a pUID 2010 field, a pATC 2012 field, a nonce 2014 field, and an encrypted cryptogram 2016.

In embodiments, the fields may be in plain text or encrypted. For example, the applet version 2002 field may include an applet version in plain text. The applet version to indicate which applet version is installed on a contactless card and may be used by the other systems to determine how to process the message 2000 when communicated. For example, different Applet versions require different validation logic, e.g., an older message may be routed through the issuer system to perform various operations for validation, while a newer message may be routed through the switchboard system to perform the various operations, including validation.

In embodiments, the message 2000 includes an issuer discretionary indicator 2004 field that may include issuer data and set at the time of personalization. In addition, the message 2000 includes an Issuer Identifier 2006 field that may include a unique ID assigned to the entity issuing the card, e.g., the issuer. For example, each issuer may be assigned a unique identifier during an onboarding operation when joining the system. The issuer ID can be used by the switchboard system 1408 to route a message and its contents to the appropriate services that are associated with that particular issuer.

In embodiments, the message 2000 includes a pKey ID 2008 field. In some instances, the pKey ID 2008 field may include data that identifies a set of master keys for a card issuer. The issuer's set of master keys may utilize each cards set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's masters keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described in FIG. 15, flow 1500.

The message 2000 may include a pUID 2010 field, including a card unique identifier assigned to the contactless card at personalization time. The pUID 2010 field data may be a combination of alphanumeric characters used to uniquely identify each card and associated with a user.

In embodiments, the message 2000 includes a pATC 2012 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 2000 is created, a new session key is derived and utilized to generate one or more portions of the message 2000. Specifically, a session key is used to calculate the cryptographic MAC (Application Cryptogram). The card's applet supports a session key derivation option to generate a unique cryptogram session key ASK as discussed in FIG. 16, flow 1600 and unique encipherment session key (DESK) as discussed in flow 1608. The generation of the cryptogram is discussed in flow 1600 and flow 1800. Further the cryptogram may be decrypted in accordance with flow block 1808.

In embodiments, a portion of the data provided in message 2000 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 1402 and a device via wired means, e.g., via the contact pad 708, and in accordance with the EMV protocol.

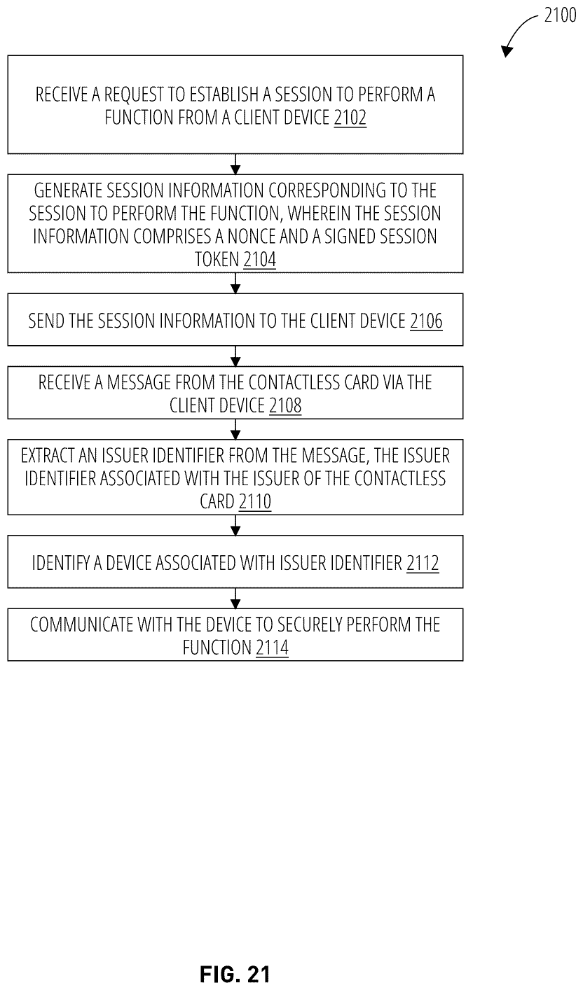

FIG. 21 illustrates an example of routine 2100 in accordance with embodiments discussed herein. In block 2102, the routine 2100 includes receiving, by a node in a system, a request to establish a session to perform a function from a client device, wherein the function is at least partially performed utilizing a contactless card. In some instances, the node may be one of a plurality nodes of a switchboard system. The node may be previously selected by the sending device via a DNS operation performed.

In block 2104, the routine 2100 includes generating, by the node, session information corresponding to the session to perform the function, wherein the session information comprises a nonce and a signed session token. The nonce and/or signed session token may be utilized by systems to perform the functions described herein while ensuring the node routing the data is authenticate, the message from the contactless card is authenticate, and to keep track of the session for the function.

In block 2106, routine 2100 includes sending, by the node, the session information to the client device. The client device may communicate with a contactless card to receive data from the card to authenticate and perform a function. In some instances, the client device may send the nonce from the node to the contactless card. The contactless card may utilize the nonce when generating the message to communicate back to the client device and finally, the node, e.g., incorporates it into a cryptographic portion of the message (as shown in FIG. 20).

In block 2108, routine 2100 includes receiving, by the node, a message from the contactless card via the client device. The message may be generated by the contactless card. FIG. 20 illustrates one example of a message 2000. In some embodiments, the node verifies the message. For example, the node may verify a nonce in the message and a signed session token.

In block 2110, routine 2100 extracts, by the node, an issuer identifier from the message, the issuer identifier associated with the issuer of the contactless card. In some instances, the issuer identifier may be in a plaintext format.

In block 2112, routine 2100 identifies, by the node, a device associated with the issuer identifier. For example, the node may perform a lookup to determine a server associated with the issuer identifier and the function to be performed.

In block 2114, routine 2100 communicates, by the node, with the device to securely perform the function.

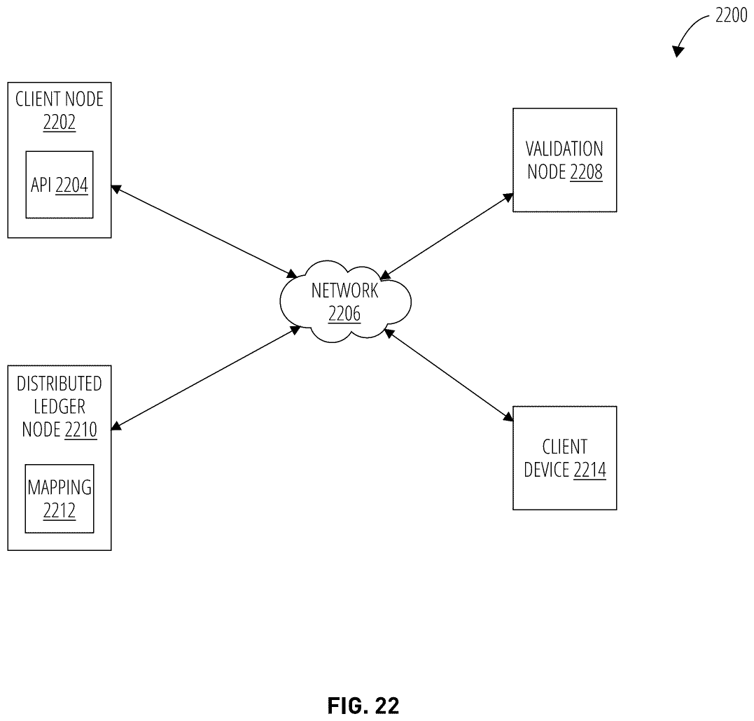

FIG. 22 illustrates a distributed network authentication system 1100 according to an example embodiment. As further discussed below, system 1100 can include client node 2202, API 2204, network 2206, distributed ledger node 2210, mapping 2212, and client device 2214. Although FIG. 22 illustrates single instances of the components, system 1100 can include any number of components.

System 1100 can include a client node 2202, which can be a network-enabled computer as described herein. In some examples, client node 2202 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, client node 2202 can execute one or more applications, such as software applications, that enable, for example, network communications with one or more components of system 1100, transmit and/or receive data, and perform the functions and processes described herein.

The client node can contain an API 2204. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 2204 to interact with the service, such as by performing a remote call to an API for interacting with a web-based service.

API 2204 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 2202 can communicate with one or more other components of system 1100 either directly or via network 2206. Network 2206 can comprise one or more of a wireless network, a wired network or any combination of wireless network and wired network and may be configured to connect the components of system 1100. While FIG. 22 illustrates communication between the components of system 1100 through network 2206, it is understood that any component of system 1100 can communicate directly with another component of system 1100, e.g., without involving network 2206.

System 1100 can include a validation node 2208, which can be a network-enabled computer as described herein. In some examples, validation node 2208 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, validation node 2208 can execute one or more applications, such as software applications, that enable, for example, network communications with one or more components of system 1100, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1100 can include a distributed ledger node 2210, which can be a network-enabled computer as described herein. In some examples, distributed ledger node 2210 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, distributed ledger node 2210 can execute one or more applications, such as software applications, that enable, for example, network communications with one or more components of system 1100, transmit and/or receive data, and perform the functions and processes described herein.

Distributed ledger node 2210 can containing a mapping 2212. In some examples, mapping 2212 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1100, or the one or more databases can be hosted externally to any component of the system 1100. In some examples, the one or more databases can be contained in the distributed ledger node 2210, and in other examples the one or more databases can be stored outside of distributed edger node 2210 but in data communication with distributed ledger node 2210. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 2210. In other examples, the one or more databases can be remote from distributed ledger node 2210 but in data communication with distributed ledger node 2210. Data communication between the one or more databases and distributed ledger node 2210 can be a direct data communication or data communication via a network, such as the network 2206.

In some examples, client node 2202 can be in data communication with distributed ledger node 2210. Distributed ledger node 2210 can contain mapping 2212. Mapping 2214 may include, e.g., a mapping between a validation node address and the validation node 2208, a mapping between a routing number and a validation node address, and/or a mapping between a routing number and validation node 2208. In some examples, mapping 2212 can include a digital signature associated with an entity having permission to validate for a routing number. Based on one or more of these associations, client node 2202 can call validation node for validation and/or provide direction to the client device to reach the appropriate validation node. This can be accomplished by calling a validation API associated with validation node 2208.

In some examples, iterations of the mappings described herein, such as mapping 2212, can also include a software or applet version number. The version number can be used to identify a validation node or validation node address or choose between multiple validation addresses for one validation node.

In some examples, client node 2202 and distributed ledger node 2210 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 2210 can update mapping 2212 to reflect a different association between, e.g., a routing number, a validation node address, and a validation node. In some examples, degrees of permissions can be issued. For example, if client node 2202 were to function to route data to validation node 2208 (or other validation nodes), client node 2202 can be given a certain level of permissions. As another example, if distributed ledger node 2210 were to have the capability to update mapping 2212, distributed ledger node 2210 can have a different, higher level of permissions.

System 1100 can include a client device 2214, which can be a network-enabled computer as described herein. In some examples, distributed ledger node 2214 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 2214 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 2214 can be in data communication with another network-enabled computer not shown in FIG. 22, such as a smart card (e.g., a contactless card or a contact-based card).

In some examples, client device 2214 can execute one or more applications, such as software applications, that enable, for example, network communications with one or more components of system 1100, transmit and/or receive data, and perform the functions and processes described herein.

In some examples, upon receipt of an authentication request, client device 2214 can call (e.g., via an API) client node 2202. The call can include a routing number and/or an applet or software version number, and client node 2202 can query distributed ledger node 2210 and mapping 2212. Once the query returns the identification of a validation node (e.g., validation node 2208) and/or a validation node address associated with that routing number and/or applet or software version, client node 2202 can reply to client device 2214. Client device 2214 can then proceed with authentication with the validation node. The authentication can be performed by, e.g., the systems and methods described herein, such as by the generation, encryption, transmission, decryption, and validation of a cryptogram as described herein.

In some examples, client node 2202 can be co-resident with validation node 2208. In these examples, client node 2202 can handle the authentication in a single call from client device 2214. In some examples, this can be acceptable only if it is permissible for the full authentication transmission (e.g., a cryptogram as described herein) to be sent to client nodes that are not involved in authentication.

In some examples, if client node 2202 receives, from client device 2214, a routing number that is not handled by its location, client node 2202 can return a code indicating that this routing number is not handled, along with validation node address for the responsible validation node. Client device 2214 can then send the full authentication transmission to validation node 2208 using the received validation node address.

In some examples, client node 2202 can enter the distributed network with different permissions. For example, client node 2202 can be a read-only router of data. As another example, client node 2202 can have permission to send messages to distributed ledger node 2210 updating one or more routing paths for one or more routing numbers. However, client node 2202 would be prevented from updating one or more routing paths for one or more routing numbers for other entities that control other routing numbers which are not associated with client node 2202 or that did not grant this permission. As another example, distributed ledger node 2210 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 2202, distributed ledger node 2210, and/or validation node 2208, if security, legal, and/or financial conditions are met, however, delegation is not required.

In some examples, one or more APIs can facilitate communication between components of system 1100 via network 2206. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 2208 for authentication, can require storage of the keys in one or more HSMs, to promote key security and ensure that the keys are never entered into memory.

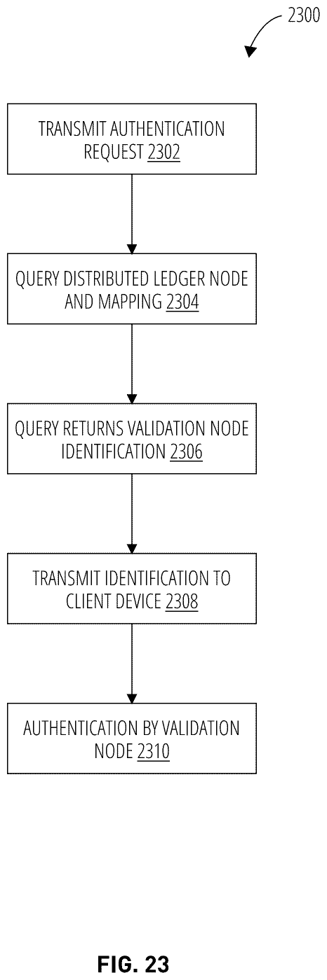

FIG. 23 illustrates a method 2300 performed by a distributed network authentication system according to an example embodiment. For example, the method can be performed by distributed network authentication system 2200 and or by another distributed network authentication system.

In block 2302, a client device can transmit an authentication request to a client node. The authentication request can include, without limitation, a routing number, a software version number, and/or an applet version number. The request can be made by an API call or other communication between the client device and the client node.

In block 2304, after receiving the authentication request, the client node can transmit a query (e.g., via an API call) to a distributed ledger node. The distributed ledger node contain a mapping, and the distributed ledger node can submit the query to the mapping.

In block 2306, the query can return an identification of a validation node and/or a validation node address, and the distributed ledger node can transmit this identification to the client node.

In block 2308, the client node can transmit the identification to the client device. After receiving the identification, the client device can proceed with authentication with the identified validation node and/or validation node address, in block 2310.

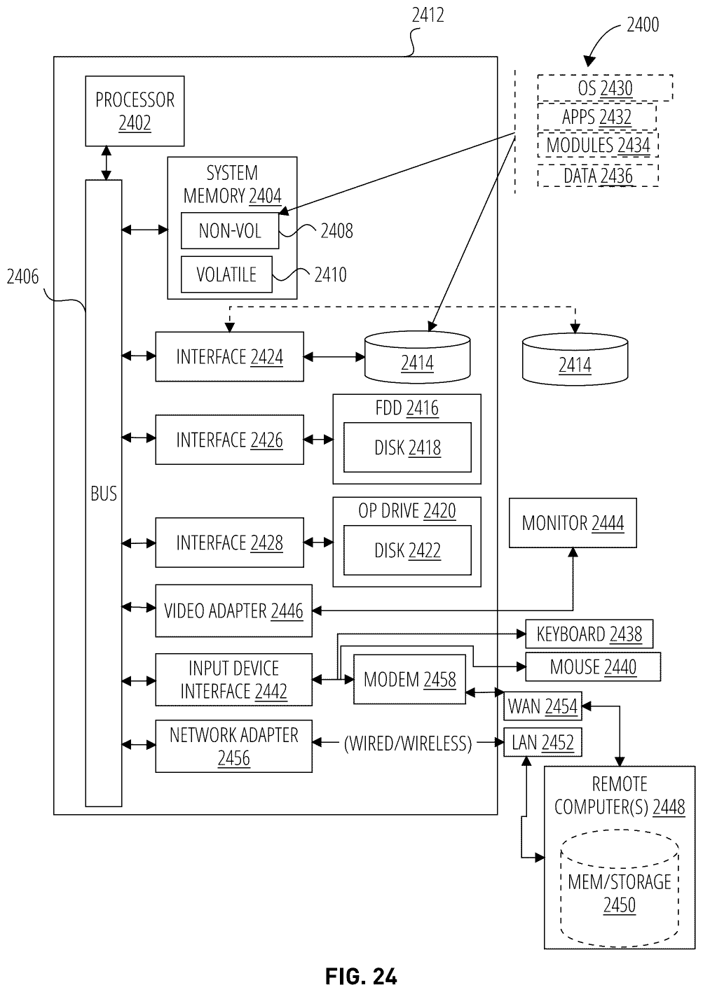

FIG. 24 illustrates an embodiment of an exemplary computer architecture 2400 suitable for implementing various embodiments as previously described. In one embodiment, the computer architecture 2400 may include or be implemented as part of computing architecture 100. For example, the computer architecture 2400 or parts of it can be used to implement the computing device 104, the contactless card 102, and the server 106. In some cases, for example, in the case of the contactless card 102, some of the components described herein may not be included.

As used in this application, the terms “system” and “component” are intended to refer to a computer-related entity, either hardware, a combination of hardware and software, software, or software in execution, examples of which are provided by the exemplary computing computer architecture 2400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 2400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 2400.

As shown in FIG. 24, the computer architecture 2400 includes a computer 2412 comprising a processor 2402, a system memory 2404 and a system bus 2406. The processor 2402 can be any of various commercially available processors. The computer 2412 may be representative of the computing device 104 and/or the server 106.

The system bus 2406 provides an interface for system components including, but not limited to, the system memory 2404 to the processor 2402. The system bus 2406 can be any of several types of bus structure that may further interconnect to a memory bus (with or without a memory controller), a peripheral bus, and a local bus using any of a variety of commercially available bus architectures. Interface adapters may connect to the system bus 2406 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI(X)), PCI Express, Personal Computer Memory Card International Association (PCMCIA), and the like.

The computer architecture 2400 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2404 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 24, the system memory 2404 can include non-volatile 2408 and/or volatile 2410. A basic input/output system (BIOS) can be stored in the non-volatile 2408.

The computer 2412 may include various types of computer-readable storage media in the form of one or more lower speed memory units, including an internal (or external) hard disk drive 2414, a magnetic disk drive 2416 to read from or write to a removable magnetic disk 2418, and an optical disk drive 2420 to read from or write to a removable optical disk 2422 (e.g., a CD-ROM or DVD). The hard disk drive 2414, magnetic disk drive 2416 and optical disk drive 2420 can be connected to the system bus 2406 by an HDD interface 2424, and FDD interface 2426 and an optical disk drive interface 2428, respectively. The HDD interface 2424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 2408, and volatile 2410, including an operating system 2430, one or more applications 2432, other program modules 2434, and program data 2436. In one embodiment, the one or more applications 2432, other program modules 2434, and program data 2436 can include, for example, the various applications and/or components of the system 100.

A user can enter commands and information into the computer 2412 through one or more wire/wireless input devices, for example, a keyboard 2438 and a pointing device, such as a mouse 2440. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, and the like. These and other input devices are often connected to the processor 2402 through an input device interface 2442 that is coupled to the system bus 2406 but can be connected by other interfaces such as a parallel port, IEEE 1394 serial port, a game port, a USB port, an IR interface, and so forth.

A monitor 2444 or other type of display device is also connected to the system bus 2406 via an interface, such as a video adapter 2446. The monitor 2444 may be internal or external to the computer 2412. In addition to the monitor 2444, a computer typically includes other peripheral output devices, such as speakers, printers, and so forth.

The computer 2412 may operate in a networked environment using logical connections via wire and/or wireless communications to one or more remote computers, such as a remote computer(s) 2448. The remote computer(s) 2448 can be a workstation, a server computer, a router, a personal computer, portable computer, microprocessor-based entertainment appliance, a peer device or other common network node, and typically includes many or all the elements described relative to the computer 2412, although, for purposes of brevity, only a memory and/or storage device 2450 is illustrated. The logical connections depicted include wire/wireless connectivity to a local area network 2452 and/or larger networks, for example, a wide area network 2454. Such LAN and WAN networking environments are commonplace in offices and companies, and facilitate enterprise-wide computer networks, such as intranets, all of which may connect to a global communications network, for example, the Internet.

When used in a local area network 2452 networking environment, the computer 2412 is connected to the local area network 2452 through a wire and/or wireless communication network interface or network adapter 2456. The network adapter 2456 can facilitate wire and/or wireless communications to the local area network 2452, which may also include a wireless access point disposed thereon for communicating with the wireless functionality of the network adapter 2456.

When used in a wide area network 2454 networking environment, the computer 2412 can include a modem 2458, or is connected to a communications server on the wide area network 2454 or has other means for establishing communications over the wide area network 2454, such as by way of the Internet. The modem 2458, which can be internal or external and a wire and/or wireless device, connects to the system bus 2406 via the input device interface 2442. In a networked environment, program modules depicted relative to the computer 2412, or portions thereof, can be stored in the remote memory and/or storage device 2450. It will be appreciated that the network connections shown are exemplary and other means of establishing a communications link between the computers can be used.

The computer 2412 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” arc used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A computer implemented method, comprising:
executing, using at least one processor, an application on a computing device upon the computing device detecting a contactless card to be located within a predetermined distance of the computing device, the computing device storing one or more computing device activation keys, the contactless card being an inactive contactless card;
accessing, using the at least one processor, the stored one or more computing device activation keys upon verifying one or more user authentication keys received in response to the executing;
receiving, using the at least one processor, one or more contactless card activation keys, the one or more contactless card activation keys being stored by the contactless card; and
activating, using the at least one processor, the contactless card based on a determination that the received one or more contactless card activation keys match the stored one or more computing device activation keys.

2. The method according to claim 1, wherein the activating includes sending the received one or more contactless card activation keys and the stored one or more computing device activation keys to at least one server, the at least one server being communicatively coupled to the computing device.

3. The method according to claim 2, wherein the at least one server is configured to execute a comparison of the received one or more contactless card activation keys and the stored one or more computing device activation keys;
determine, based on the comparison, whether the received one or more contactless card activation keys match the stored one or more computing device activation keys;
upon a determination of a match between the received one or more contactless card activation keys and the stored one or more computing device activation keys, transmit an activation signal to the contactless card to activate the contactless card; and
upon a failure to determine a match between the received one or more contactless card activation keys and the stored one or more computing device activation keys, prevent transmission of the activation signal to the contactless card.

4. The method according to claim 3, wherein the at least one server is configured to transmit the one or more computing device activation keys to the computing device.

5. The method according to claim 1, wherein the executing includes executing a near-field communication (NFC) exchange between the contactless card and the computing device upon the contactless card being detected by the computing device to be located within the predetermined distance of the computing device.

6. The method according to claim 5, wherein the executing includes automatically triggering, based on the NFC exchange, generation of at least one user interface, the at least one user interface including one or more prompts for entry of the one or more user authentication keys.

7. The method according to claim 6, wherein the one or more user authentication keys includes at least one of the following: a facial recognition data, a fingerprint data, a biometric data, a username and a password, a multi-factor authentication token, and any combination thereof.

8. The method according to claim 1, wherein the contactless card includes at least one of the following: a credit card, a debit card, an electronic gift card, a pre-paid credit card, a pre-paid debit card, and any combination thereof.

9. The method according to claim 1, wherein the computing device is configured to execute a comparison of the received one or more contactless card activation keys and the stored one or more computing device activation keys;
determine, based on the comparison, whether the received one or more contactless card activation keys match the stored one or more computing device activation keys;
upon a determination of a match between the received one or more contactless card activation keys and the stored one or more computing device activation keys, transmit an activation signal to the contactless card to activate the contactless card; and
upon a failure to determine a match between the received one or more contactless card activation keys and the stored one or more computing device activation keys, prevent transmission of the activation signal to the contactless card.

10. A system, comprising:
at least one processor; and
at least one non-transitory storage media storing instructions, that when executed by the at least one processor, cause the at least one processor to perform operations including
executing an application on a computing device upon the computing device detecting a contactless card to be located within a predetermined distance of the computing device, the computing device storing one or more computing device activation keys, the contactless card being an inactive contactless card;
accessing the stored one or more computing device activation keys upon verifying one or more user authentication keys received in response to the executing;
receiving one or more contactless card activation keys, the one or more contactless card activation keys being stored by the contactless card; and
executing a comparison of the received one or more contactless card activation keys and the stored one or more computing device activation keys;
determining, based on the comparison, whether the received one or more contactless card activation keys match the stored one or more computing device activation keys;
upon a determination of a match between the received one or more contactless card activation keys and the stored one or more computing device activation keys, sending an activation signal to the contactless card to activate the contactless card; and
upon a failure to determine a match between the received one or more contactless card activation keys and the stored one or more computing device activation keys, preventing activation of the contactless card.

11. The system according to claim 10, wherein the executing of the comparison includes sending the received one or more contactless card activation keys and the stored one or more computing device activation keys to at least one server, the at least one server being communicatively coupled to the computing device.

12. The system according to claim 11, wherein the at least one server is configured to transmit the activation signal to the contactless card to activate the contactless card.

13. The system according to claim 12, wherein the at least one server is configured to transmit the one or more computing device activation keys to the computing device.

14. The system according to claim 10, wherein the executing the application includes executing a near-field communication (NFC) exchange between the contactless card and the computing device upon the contactless card being detected by the computing device to be located within the predetermined distance of the computing device.

15. The system according to claim 14, wherein the executing the application includes automatically triggering, based on the NFC exchange, generation of at least one user interface, the at least one user interface including one or more prompts for entry of the one or more user authentication keys.

16. The system according to claim 15, wherein the one or more user authentication keys includes at least one of the following: a facial recognition data, a fingerprint data, a biometric data, a username and a password, a multi-factor authentication token, and any combination thereof.

17. The system according to claim 10, wherein the contactless card includes at least one of the following: a credit card, a debit card, an electronic gift card, a pre-paid credit card, a pre-paid debit card, and any combination thereof.

18. The system according to claim 10, wherein the computing device is configured to the comparison of the received one or more contactless card activation keys and the stored one or more computing device activation keys.

19. The system according to claim 18, wherein the computing device is configured to transmit the activation signal to the contactless card to activate the contactless card.

20. A method computer program product comprising a non-transitory machine-readable medium storing instructions that, when executed by at least one programmable processor, cause the at least one programmable processor to perform operations comprising:
executing a near-field communication (NFC) exchange between a contactless card and a computing device upon the contactless card being detected by the computing device to be located within a predetermined distance of the computing device, and automatically triggering, based on the NFC exchange, generation of at least one user interface by one or more applications executable by the computing device, the at least one user interface including one or more prompts for entry of one or more user authentication keys, the computing device storing one or more computing device activation keys, the contactless card being an inactive contactless card;
verifying the one or more user authentication keys received in response to the executing and accessing the one or more computing device activation keys;
receiving one or more contactless card activation keys, the one or more contactless card activation keys being stored by the contactless card; and
activating the contactless card based on a determination that the received one or more contactless card activation keys match the one or more computing device activation keys.
